(19) United States
(12) Patent Application Publication
(10) Pub. No.: US 2026/0253875 A1
(43) Pub. Date: Aug. 27, 2026

(54) SOLID-STATE BATTERIES WITH ALUMINUM-BASED COMPOSITE FOIL ANODES EXHIBITING MULTIPHASE MICROSTRUCTURE

(71) Applicant: Georgia Tech Research Corporation, Atlanta, GA (US)

(72) Inventors: Diptarka Majumdar, Cumming, GA (US); Rajesh Gopalaswamy, Alpharetta, GA (US); DaeHoon Kang, Canton, GA (US); Matthew McDowell, Decatur, GA (US); Yuhgene Liu, Atlanta, GA (US); Congcheng Wang, Atlanta, GA (US); Philippe Meyer, Agnetz (FR); Sazol Kumar Das, Acworth, GA (US)

(21) Appl. No.: 19/160,157

(22) PCT Filed: Mar. 6, 2024
(86) PCT No.: PCT/US2024/018651

§ 371 Date: Aug. 27, 2025

Related U.S. Application Data
(60) Provisional application No. 63/488,847, filed on Mar. 7, 2023.

(51) Int. Cl. H01M 4/36; H01M 4/02; H01M 4/40; H01M 4/46; H01M 10/04; H01M 10/052; H01M 10/0562

(52) U.S. Cl. CPC H01M 4/364; H01M 4/405; H01M 4/463; H01M 10/0468; H01M 10/052; H01M 10/0562; H01M 2004/021; H01M 2004/027; H01M 2300/0068

(57) ABSTRACT

Described herein are solid-state electrochemical cells incorporating a composite foil as an anode, the composite foil including a first metal phase comprising aluminum or an aluminum alloy and a second phase interspersed with the first metal phase. The use of the composite foil as an anode active material can provide for improved cycling stability due to maintaining mechanical integrity despite volume changes during cycling as compared to conventional liquid-electrolyte electrochemical cells that fail due to excessive SEI growth. A layered multiphase microstructure formed by including the second metal phase enables improved diffusion characteristics and mitigation of lithium trapping, improving rate behavior, initial Coulombic efficiency, and attained capacity as compared to electrochemical cells solely using aluminum or an aluminum alloy as the anode active material.

### CROSS-REFERENCE TO RELATED APPLICATION

This application claims the benefit of and priority to U.S. Provisional Patent Application No. 63/488,847, filed on Mar. 7, 2023, the content of which is hereby incorporated by reference in its entirety.

### FIELD

The present disclosure relates to metallurgy generally and more specifically to solid-state batteries containing aluminum-based composite foil anodes exhibiting multiphase microstructures.

### BACKGROUND

Conventional lithium-ion batteries generally include a cathode, an anode, and a separator soaked with an electrolyte between them. Current collectors on the cathode side and the anode side are used to conduct electrical current to or from the cathode and the anode, while the electrolyte allows lithium ions to transport between the cathode and the anode. Due to the potentials involved, copper is generally used as an anode current collector and aluminum is generally used as the cathode current collector. Lithium metal oxides, like lithium cobalt oxide, are commonly used as lithium-ion battery cathodes, and graphite is commonly used as lithium-ion battery anodes.

### SUMMARY

The term embodiment and like terms are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this disclosure, any or all drawings and each claim.

In an aspect, described herein are solid-state batteries. In some examples, a solid-state battery may comprise an anode, a cathode, and a solid-state electrolyte between the anode and the cathode. For example, the anode may comprise a composite foil including a first metal phase comprising aluminum or an aluminum alloy, such as where the first metal phase comprises or represents from 50 at % to 99 at % of the composite foil, and a second metal phase interspersed with the first metal phase, such as a second metal phase comprising a conductive element having a lithium alloying potential that is higher than or about equal to that of aluminum. In examples, a lithiated form of the conductive element exhibits a lithium-ion conductivity or diffusion coefficient greater than or about equal to that of lithiated aluminum. In examples, the second metal phase comprises or represents from 1 at % to 50 at % of the composite foil.

Any suitable aluminum alloy may be used in the solid-state batteries described herein, such as for the first metal phase of the anode material. In various examples, the first metal phase may comprise a 1xxx series aluminum alloy, a 2xxx series aluminum alloy, a 3xxx series aluminum alloy, a 4xxx series aluminum alloy, a 5xxx series aluminum alloy, a 6xxx series aluminum alloy, a 7xxx series aluminum alloy, an 8xxx series aluminum alloy, and/or a recycled content aluminum alloy.

Various conductive elements or metals may be used in the solid-state batteries described herein. For example, the conductive element may be, but is not limited to, silicon, tin, indium, carbon, gallium, antimony, lead, nickel, copper, germanium, zinc, bismuth, magnesium, manganese, and/or silver.

In some examples, the second phase is present as a plurality of individual domains within the first metal phase. For example, at least some of the individual domains exhibit a cross-sectional dimension of less than or about 5 μm, such as less than or about 4 μm, less than or about 3 μm, less than or about 2 μm, or less than or about 1 μm.

In some examples, the anode may be in a lithiated form. For example, the second metal phase may optionally comprise the lithiated form of the conductive element. In some examples, the first metal phase may optionally comprise the lithiated form of the aluminum alloy. In a specific example, the conductive element comprises In and the second metal phase comprises Li—In.

Optionally, the composite foil may exhibit a lithium diffusion coefficient of from about 10⁻⁵ cm² s⁻¹ to 10⁻¹⁰ cm² s⁻¹. For example, the composite metal foil may comprise one or more lithiated regions exhibiting a lithium diffusion coefficient of from about 10⁻⁵ cm² s⁻¹ to 10⁻¹⁰ cm² s⁻¹.

In various examples, any suitable solid-state electrolyte may be used with the solid-state batteries described herein. For example, the solid-state electrolyte may be or comprise an inorganic solid electrolyte. Optionally, the solid-state electrolyte comprises a lithium argyrodite material, such as Li₆PS₅Cl, a lithium super ionic conductor (LISICON), a doped garnet material, such as Li₇La₃Zr₂O₁₂ (LLZO), Li₁₀GeP₂S₁₂, Li₁₀SnP₂S₁₂, lithium phosphorus sulfide (Li₃PS₄), halide materials, such as Li₃YCl₆, lithium phosphorus oxynitride (LIPON), a polymer solid electrolyte, or a gel-polymer electrolyte. Optionally, the solid-state electrolyte has a thickness of from 10 μm to 300 μm.

The anode material may take up lithium during charging and release lithium during discharging. Upon uptake of lithium, the anode material may undergo a volume increase, and undergo volume decrease during lithium release. In some cases, the amount of volume decrease may be equal to or less than the volume increase, such that after a number of charge-discharge cycles the anode may be larger than the anode before any charge-discharge cycles. However, the volume increase may be limited using the composite foil anode materials described herein. For example, the composite foil exhibits a change in thickness after 100 charge-discharge cycles of less than 50%.

Any suitable cathode may be used with the solid-state batteries described herein. For example, the cathode may comprise a lithium host material, a lithium transition metal oxide cathode, lithium nickel manganese cobalt oxide, lithium nickel cobalt aluminum oxide, lithium manganese oxide, lithium iron phosphate, lithium cobalt oxide, a conversion cathode, lithiated FeS₂, lithiated FeF₃, a sulfur-based cathode, or sulfur.

Optionally, the solid-state batteries described may further comprise one or more of: a cathode current collector in contact with the cathode; or an anode current collector in contact with the anode. Optionally, the anode current collector comprises a protected aluminum alloy foil. Optionally, however, the solid-state battery may not include or comprise an anode current collector. For example, in some cases the composite foil may function as an anode current collector without a separate anode current collector.

In various examples, a stack pressure is applied between the anode and the cathode, such as a stack pressure of from about 0.1 MPa to about 70 MPa. Optionally, wherein the composite metal foil has a thickness of from about 2 μm to about 60 μm.

Optionally, the composite foil exhibits a specific capacity of from about 300 mAh/g to about 1000 mAh/g.

In some examples, a solid-state battery of this aspect may further comprise an interface material between the anode and the solid-state electrolyte, such as a solid-electrolyte interphase, an artificial solid-electrolyte interphase, a polymer coating, a carbon coating, or an inorganic coating.

In another aspect, methods of making solid-state batteries are described. In some examples, a method of this aspect comprises providing an anode; providing a cathode; and positioning a solid-state electrolyte between the anode and the cathode. Optionally, methods of this aspect may further comprise one or more of: contacting the anode with an anode current collector; or contacting the cathode with a cathode current collector. Methods of this aspect may be used to prepare any of the solid-state batteries described herein.

In some examples, the anode may comprise a composite foil as described herein, such as including a first metal phase comprising aluminum or an aluminum alloy, such as a first metal phase comprising or representing from 50 at % to 99 at % of the composite foil; and a second metal phase interspersed with the first metal phase, such as a second metal phase comprising a conductive element having a lithium alloying potential that is higher than or about equal to that of aluminum. Optionally, a lithiated form of the conductive element exhibits a lithium-ion conductivity or diffusion coefficient greater than or about equal to that of lithiated aluminum. Optionally, the second metal phase comprises or represents from 1 at % to 50 at % of the composite foil.

In some examples, providing the anode comprises casting a molten metal mixture comprising aluminum or the aluminum alloy and the conductive element to create an aluminum-based multi-component product; and rolling the aluminum-based multi-component product into the composite foil.

Other objects and advantages will be apparent from the following detailed description of non-limiting examples.

### BRIEF DESCRIPTION OF THE FIGURES

The specification makes reference to the following appended figures, in which use of like reference numerals in different figures is intended to illustrate like or analogous components.

FIG. 1 provides a schematic overview of an example method for making a rolled aluminum alloy product.

FIG. 2 provides a schematic illustration of an example solid-state electrochemical cell including an anode comprising aluminum as an anode active material.

FIG. 3 provides a cross-sectional backscattered electron micrograph image showing an example aluminum alloy-based anode comprising 94.5 at % aluminum and 5.5 at % indium with a thickness of 30 μm.

FIG. 4 provides X-ray diffraction spectra of an example aluminum foil, an example indium foil, and an example aluminum alloy-based foil comprising 94.5 at % aluminum and 5.5 at % indium.

FIG. 5 provides an X-ray spectroscopy map of aluminum signal for an example aluminum alloy-based foil comprising 94.5 at % aluminum and 5.5 at % indium.

FIG. 6 provides an X-ray spectroscopy map of indium signal for an example aluminum alloy-based foil comprising 94.5 at % aluminum and 5.5 at % indium.

FIG. 7 provides charge and discharge curves for an example solid-state electrochemical cell including an aluminum alloy-based anode comprising 94.5 at % aluminum and 5.5 at % indium and cycled at 0.2 mA cm⁻² for the first two cycles, 0.4 mA cm⁻² for the next three cycles, and 0.8 mA cm⁻² for subsequent cycles.

FIG. 8 provides charge and discharge curves for an example solid-state electrochemical cell including a high-purity (99.999%) aluminum anode cycled at 0.2 mA cm⁻² for the first two cycles, 0.4 mA cm⁻² for the next three cycles, and 0.8 mA cm⁻² for subsequent cycles.

FIG. 9 provides galvanostatic cycling data for an example solid-state electrochemical cell including an aluminum alloy-based anode comprising 94.5 at % aluminum and 5.5 at % indium and another example solid-state electrochemical cell including a high-purity (99.999%) aluminum anode, the example solid-state electrochemical cell and the other example solid-state electrochemical cell being cycled at 0.8 mA cm⁻² for the first cycle and 6.5 mA cm⁻² for cycles 2-200.

FIG. 10 provides differential capacity curves for the first two cycles of an example solid-state electrochemical cell including an aluminum alloy-based anode comprising 94.5 at % aluminum and 5.5 at % indium.

FIG. 11 provides differential capacity curves comparing the first cycle of an example solid-state electrochemical cell including a high-purity (99.999%) aluminum anode to the first cycle of another example solid-state electrochemical cell including an aluminum alloy-based anode comprising 94.5 at % aluminum and 5.5 at % indium.

FIG. 12 provides Coulombic efficiency data for an example solid-state electrochemical cell including an aluminum alloy-based anode comprising 94.5 at % aluminum and 5.5 at % indium and another example solid-state electrochemical cell including a high-purity (99.999%) aluminum anode, the example solid-state electrochemical cell and the other example solid-state electrochemical cell being cycled at 0.8 mA cm⁻² for the first cycle and 6.5 mA cm⁻² for subsequent cycles.

FIG. 13 provides galvanostatic cycling data for an example solid-state electrochemical cell including an aluminum alloy-based anode comprising 94.5 at % aluminum and 5.5 at % indium and another example solid-state electrochemical cell including a high-purity (99.999%) aluminum anode, the example solid-state electrochemical cell and the other example solid-state electrochemical cell being cycled at 0.2 mA cm⁻² for the first two cycles, 0.4 mA cm⁻² for the next three cycles, and 0.8 mA cm⁻² for subsequent cycles.

FIG. 14 provides Coulombic efficiency data for an example solid-state electrochemical cell including an aluminum alloy-based anode comprising 94.5 at % aluminum and 5.5 at % indium and another example solid-state electrochemical cell including a high-purity (99.999%) aluminum anode, the example solid-state electrochemical cell and the other example solid-state electrochemical cell being cycled at 0.2 mA cm⁻² for the first two cycles, 0.4 mA cm⁻² for the next three cycles, and 0.8 mA cm⁻² for subsequent cycles.

FIG. 15 provides charge and discharge curves for an example solid-state electrochemical cell including an aluminum alloy-based anode comprising 94.5 at % aluminum and 5.5 at % indium and cycled at 0.8 mA cm⁻² for the first cycle and 6.5 mA cm⁻² for subsequent cycles.

FIG. 16 provides charge and discharge curves for an example solid-state electrochemical cell including a high-purity (99.999%) aluminum anode and cycled at 0.8 mA cm⁻² for the first cycle and 6.5 mA cm⁻² for subsequent cycles.

FIG. 17 provides charge and discharge curves for an example half-cell including a high-purity (99.999%) aluminum anode, a lithium metal counter electrode, and liquid electrolyte cycled at 1 mA cm⁻² current density.

FIG. 18 provides charge and discharge curves for an example half-cell including an aluminum alloy-based anode comprising 94.5 at % aluminum and 5.5 at % indium, a lithium metal counter electrode, and liquid electrolyte cycled at 1 mA cm⁻² current density.

FIG. 19 provides areal capacity and Coulombic efficiency data for an example half-cell including a high-purity (99.999%) aluminum anode, a lithium metal counter electrode, and liquid electrolyte cycled at 1 mA cm⁻² current density.

FIG. 20 provides areal capacity and Coulombic efficiency data for an example half-cell including an aluminum alloy-based anode comprising 94.5 at % aluminum and 5.5 at % indium, a lithium metal counter electrode, and liquid electrolyte cycled at 1 mA cm⁻² current density.

FIG. 21A provides charge and discharge curves for an example solid-state electrochemical cell including an aluminum alloy-based anode comprising 94.5 at % AA1235 aluminum and 5.5 at % indium and a reference cell including an aluminum alloy anode including AA1235.

FIG. 21B provides charge and discharge curves for an example solid-state electrochemical cell including an aluminum alloy-based anode comprising 94.5 at % AA6016 aluminum and 5.5 at % indium and a reference cell including an aluminum alloy anode including AA6016.

FIG. 21C provides charge and discharge curves for an example solid-state electrochemical cell including an aluminum alloy-based anode comprising 94.5 at % AA8111 aluminum and 5.5 at % indium and a reference cell including an aluminum alloy anode including AA8111.

FIG. 22 provides charge and discharge curves for example electrochemical cells including an aluminum alloy-based anode comprising 94.5 at % of a respective aluminum alloy and 5.5 at % of indium and a comparative electrochemical cell including a high-purity (99.999%) aluminum anode.

FIG. 23 provides rate testing data for an example solid-state electrochemical cell including a high-purity (99.999%) aluminum anode and another example solid-state electrochemical cell including an aluminum alloy-based anode comprising 94.5 at % aluminum and 5.5 at % indium.

FIG. 24 provides Nyquist plots and an equivalent circuit of an example solid-state electrochemical cell including a high-purity (99.999%) aluminum anode and another example solid-state electrochemical cell including an aluminum alloy-based anode comprising 94.5 at % aluminum and 5.5 at % indium.

FIG. 25 provides a subsection of Nyquist plots for an example solid-state electrochemical cell including a high-purity (99.999%) aluminum anode and another example solid-state electrochemical cell including an aluminum alloy-based anode comprising 94.5 at % aluminum and 5.5 at % indium.

FIG. 26 provides galvanostatic intermittent titration technique (GITT) measurements of an example solid-state half-cell including a high-purity (99.999%) aluminum anode and a lithium metal counter electrode at 10 MPa stack pressure and another example solid-state half-cell including an aluminum alloy-based anode comprising 94.5 at % aluminum and 5.5 at % indium and another lithium metal counter electrode at 10 MPa stack pressure.

FIG. 27 provides additional galvanostatic intermittent titration technique (GITT) measurements of an example solid-state half-cell including a high-purity (99.999%) aluminum anode and a lithium metal counter electrode at 10 MPa stack pressure and another example solid-state half-cell including an aluminum alloy-based anode comprising 94.5 at % aluminum and 5.5 at % indium and another lithium metal counter electrode at 10 MPa stack pressure.

FIG. 28 provides X-ray diffraction spectra of an example aluminum foil in pristine state, after initial charge, after initial discharge, and after cycling in a discharge state.

FIG. 29 provides X-ray diffraction spectra of an example aluminum alloy-based anode comprising 94.5 at % aluminum and 5.5 at % indium in pristine state, after initial charge, after initial discharge, and after cycling in a discharge state.

FIG. 30 provides an electron micrograph image showing an example pristine high-purity (99.999%) aluminum foil.

FIG. 31 provides an electron micrograph image showing an example pristine aluminum alloy-based foil comprising 94.5 at % aluminum and 5.5 at % indium.

FIG. 32 provides an electron micrograph image showing an example high-purity (99.999%) aluminum foil in a discharged state after one cycle cycled at 0.8 mA cm⁻² in a solid-state electrochemical cell.

FIG. 33 provides an electron micrograph image showing an example aluminum alloy-based foil comprising 94.5 at % aluminum and 5.5 at % indium in a discharged state after one cycle cycled at 0.8 mA cm⁻² in a solid-state electrochemical cell.

FIG. 34 provides an electron micrograph image showing an example high-purity (99.999%) aluminum foil in a discharged state after 125 cycles cycled at 0.8 mA cm⁻² in a solid-state electrochemical cell.

FIG. 35 provides an image of an example high-purity (99.999%) aluminum foil in a discharged state after 125 cycles cycled at 0.8 mA cm⁻² in a solid-state electrochemical cell.

FIG. 36 provides an electron micrograph image showing an example aluminum alloy-based foil comprising 94.5 at % aluminum and 5.5 at % indium in a discharged state after 100 cycles cycled at 0.8 mA cm⁻² in a solid-state electrochemical cell.

FIG. 37 provides an example aluminum alloy-based foil comprising 94.5 at % aluminum and 5.5 at % indium in a discharged state after 100 cycles cycled at 0.8 mA cm⁻² in a solid-state electrochemical cell.

FIG. 38 provides a cross-sectional electron micrograph image showing an example high-purity (99.999%) aluminum anode after failure when cycling to 59 cycles at 1 mA cm⁻² in a liquid-electrolyte half-cell.

FIG. 39 provides a cross-sectional electron micrograph image showing an example aluminum alloy-based anode comprising 94.5 at % aluminum and 5.5 at % indium after failure when cycling to 54 cycles at 1 mA cm⁻² in a liquid-electrolyte half-cell.

FIG. 40 provides a magnified image showing porosity within an example high-purity (99.999%) aluminum anode with an inset top-down photograph of the example high-purity aluminum anode.

FIG. 41 provides a magnified image showing porosity within an example aluminum alloy-based anode comprising 94.5 at % aluminum and 5.5 at % indium with an inset top-down photograph of the example aluminum alloy-based anode.

FIG. 42 provides a cross-sectional electron micrograph image showing an example aluminum alloy-based anode comprising 90.0 at % aluminum and 10 at % indium.

FIG. 43 provides an X-ray spectroscopy map of indium signal for an example aluminum alloy-based foil comprising 90.0 at % aluminum and 10 at % indium.

FIG. 44 provides a cross-sectional electron micrograph image showing an example aluminum alloy-based anode comprising 94.5 at % aluminum and 5.5 at % indium.

FIG. 45 provides an X-ray spectroscopy map of indium signal for an example aluminum alloy-based foil comprising 94.5 at % aluminum and 5.5 at % indium.

FIG. 46 provides a cross-sectional electron micrograph image showing an example aluminum alloy-based anode comprising 97.5 at % aluminum and 2.5 at % indium.

FIG. 47 provides an X-ray spectroscopy map of indium signal for an example aluminum alloy-based foil comprising 97.5 at % aluminum and 2.5 at % indium.

FIG. 48 provides a cross-sectional electron micrograph image showing an example aluminum alloy-based anode comprising 98.8 at % aluminum and 1.2 at % indium.

FIG. 49 provides an X-ray spectroscopy map of indium signal for an example aluminum alloy-based foil comprising 98.8 at % aluminum and 1.2 at % indium.

FIG. 50 provides a cross-sectional electron micrograph image showing an example aluminum alloy-based anode comprising 99.8 at % aluminum and 0.2 at % indium.

FIG. 51 provides an X-ray spectroscopy map of indium signal for an example aluminum alloy-based foil comprising 99.8 at % aluminum and 0.2 at % indium.

FIG. 52 provides charge and discharge curves for a set of example solid-state electrochemical cells including aluminum alloy-based anodes comprising 90.0 at % aluminum and 10 at % indium, 94.5 at % aluminum and 5.5 at % indium, 97.5 at % aluminum and 2.5 at % indium, 98.8 at % aluminum and 1.2 at % indium, and 99.8 at % aluminum and 0.2 at % indium cycled at 0.8 mA cm⁻².

FIG. 53 provides areal capacity data for a set of example solid-state electrochemical cells including aluminum alloy-based anodes comprising 90.0 at % aluminum and 10 at % indium, 94.5 at % aluminum and 5.5 at % indium, 97.5 at % aluminum and 2.5 at % indium, 98.8 at % aluminum and 1.2 at % indium, and 99.8 at % aluminum and 0.2 at % indium cycled at 0.8 mA cm⁻².

FIG. 54 provides Coulombic efficiency data for a set of example solid-state electrochemical cells including aluminum alloy-based anodes comprising 90.0 at % aluminum and 10 at % indium, 94.5 at % aluminum and 5.5 at % indium, 97.5 at % aluminum and 2.5 at % indium, 98.8 at % aluminum and 1.2 at % indium, and 99.8 at % aluminum and 0.2 at % indium cycled at 0.8 mA cm⁻².

FIG. 55 provides first-cycle voltage curves for a set of example solid-state electrochemical cells including aluminum alloy-based anodes comprising 94.5 at % aluminum and 5.5 at % indium cycled with a stack pressure of 15 MPa, 24 MPa, 50 MPa, or 70 MPa.

FIG. 56 provides voltage curves of a tenth cycle for a set of example solid-state electrochemical cells including aluminum alloy-based anodes comprising 94.5 at % aluminum and 5.5 at % indium cycled with a stack pressure of 15 MPa, 24 MPa, 50 MPa, or 70 MPa.

FIG. 57 provides a plot comparing theoretical stack-level specific energy and energy density of a lithium-ion battery with a graphite composite anode and liquid electrolyte, a solid-state battery with 1×excess lithium metal at the anode, another solid-state battery with a dense silicon anode, and another solid-state battery with a dense aluminum foil anode.

FIG. 58 provides a schematic of a solid-state electrochemical cell with an aluminum-based foil anode, solid separator, and composite cathode.

### DETAILED DESCRIPTION

Described herein are solid-state electrochemical cells incorporating a solid-state electrolyte and an aluminum-based composite foil with multiple phases as the anode active material. The use of aluminum as an anode active material can drive an increase in energy density and specific energy as compared to cells using conventional anode materials (e.g., graphite), improved safety in secondary cells as compared to cells using lithium metal anodes or compared to cells using liquid electrolytes, and avoids, at least for the anode side, wet processing, use of liquid solvents during manufacturing, and use of liquid electrolytes. Additionally, using an aluminum-based composite foil that exhibits multiphase microstructure can improve rate behavior and attained capacity due to improved diffusion characteristics and mitigation of lithium trapping. These improvements may enable high-energy-density batteries that avoid degradation challenges associated with lithium metal anodes.

The aluminum anode active material can comprise a lithium alloying anode. For example, lithium can alloy with aluminum at low potentials, where lithium ions can be reduced and incorporated into the bulk of the aluminum material as an alloy. The aluminum used for the anode active material can be a foil (e.g., a composite foil), such as a foil that comprises aluminum or an aluminum alloy as a first metal phase and including one or more other elements in an amount from about 1 at % to about 50 at % of the foil as a second metal phase interspersed with the first metal phase. Examples of the one or more other elements can include silicon, tin, indium, bismuth, magnesium, manganese, gallium, antimony, lead, nickel, copper, zinc, carbon, germanium, silver, etc. In examples, the aluminum or aluminum alloy as the first metal phase may be present in amounts from 50 at % to 55 at %, from 55 at % to 60 at %, from 60 at % to 65 at %, from 65 at % to 70 at %, from 70 at % to 75 at %, from 75 at % to 80 at %, from 80 at % to 85 at %, from 85 at % to 90 at %, from 90 at % to 95 at %, or from 95 at % to 99 at %. In examples, the one or more other elements as the second metal phase may be present in amounts from 1 at % to 5 at %, from 5 at % to 10 at %, from 10 at % to 15 at %, from 15 at % to 20 at %, from 20 at % to 25 at %, from 25 at % to 30 at %, from 30 at % to 35 at %, from 35 at % to 40 at %, from 40 at % to 45 at %, or from 45 at % to 50 at %. Specifically, the one or more elements included in the foil can comprise a conductive element having a lithium alloying potential higher than, similar to, or about equal to that of aluminum such that lithium-ion transport within the foil is enhanced to improve rate behavior and reversibility. This metallurgical design of the foil can improve cycling performance of the solid-state electrochemical cells while simplifying manufacturing processes.

As described herein, foils can be processed using metal casting and rolling processes, but other techniques can be used to prepare foils including powder-based sintering or laser melting processes, such as laser powder bed fusion techniques. Further, foils can be prepared to have an engineered structure, such as by using powder metallurgy techniques, forming a micro-porous or nano-porous structure by additive manufacturing, using metallic foams, forming perforations by laser or deep etching, de-alloying (e.g., chemical de-alloying), or other methods. In some examples, a metal product prepared by a powder-based or engineering process can be subjected to rolling to at least partially consolidate and/or make a foil from the metal product.

### Definitions and Descriptions

As used herein, the terms “invention,” “the invention,” “this invention” and “the present invention” are intended to refer broadly to all of the subject matter of this patent application and the claims below. Statements containing these terms should be understood not to limit the subject matter described herein or to limit the meaning or scope of the patent claims below.

In this description, reference is made to alloys identified by AA numbers and other related designations, such as “series” or “7xxx.” For an understanding of the number designation system most commonly used in naming and identifying aluminum and its alloys, see “International Alloy Designations and Chemical Composition Limits for Wrought Aluminum and Wrought Aluminum Alloys” or “Registration Record of Aluminum Association Alloy Designations and Chemical Compositions Limits for Aluminum Alloys in the Form of Castings and Ingot,” both published by The Aluminum Association.

As used herein, a plate generally has a thickness of greater than about 15 mm. For example, a plate may refer to an aluminum product having a thickness of greater than about 15 mm, greater than about 20 mm, greater than about 25 mm, greater than about 30 mm, greater than about 35 mm, greater than about 40 mm, greater than about 45 mm, greater than about 50 mm, or greater than about 100 mm.

As used herein, a shate (also referred to as a sheet plate) generally has a thickness of from about 4 mm to about 15 mm. For example, a shate may have a thickness of about 4 mm, about 5 mm, about 6 mm, about 7 mm, about 8 mm, about 9 mm, about 10 mm, about 11 mm, about 12 mm, about 13 mm, about 14 mm, or about 15 mm.

As used herein, a sheet generally refers to an aluminum product having a thickness of less than about 4 mm. For example, a sheet may have a thickness of less than about 4 mm, less than about 3 mm, less than about 2 mm, less than about 1 mm, less than about 0.5 mm, or less than about 0.3 mm (e.g., about 0.2 mm).

Reference may be made in this application to alloy temper or condition. For an understanding of the alloy temper descriptions most commonly used, see “American National Standards (ANSI) H35 on Alloy and Temper Designation Systems.” An F condition or temper refers to an aluminum alloy as fabricated. An O condition or temper refers to an aluminum alloy after annealing. An Hxx condition or temper, also referred to herein as an H temper, refers to a non-heat treatable aluminum alloy after cold rolling with or without thermal treatment (e.g., annealing). Suitable H tempers include HX1, HX2, HX3 HX4, HX5, HX6, HX7, HX8, or HX9 tempers. A T1 condition or temper refers to an aluminum alloy cooled from hot working and naturally aged (e.g., at room temperature). A T2 condition or temper refers to an aluminum alloy cooled from hot working, cold worked and naturally aged. A T3 condition or temper refers to an aluminum alloy solution heat treated, cold worked, and naturally aged. A T4 condition or temper refers to an aluminum alloy solution heat treated and naturally aged. A T5 condition or temper refers to an aluminum alloy cooled from hot working and artificially aged (at elevated temperatures). A T6 condition or temper refers to an aluminum alloy solution heat treated and artificially aged. A T7 condition or temper refers to an aluminum alloy solution heat treated and artificially overaged. A T8x condition or temper refers to an aluminum alloy solution heat treated, cold worked, and artificially aged. A T9 condition or temper refers to an aluminum alloy solution heat treated, artificially aged, and cold worked. A W condition or temper refers to an aluminum alloy after solution heat treatment.

As used herein, terms such as “cast metal product,” “cast product,” “cast aluminum alloy product,” and the like are interchangeable and refer to a product produced by direct chill casting (including direct chill co-casting) or semi-continuous casting, continuous casting (including, for example, by use of a twin belt caster, a twin roll caster, a block caster, or any other continuous caster), electromagnetic casting, hot top casting, or any other casting method.

As used herein, the meaning of “room temperature” can include a temperature of from about 15° C. to about 30° C., for example about 15° C., about 16° C., about 17° C., about 18° C., about 19° C., about 20° C., about 21° C., about 22° C., about 23° C., about 24° C., about 25° C., about 26° C., about 27° C., about 28° C., about 29° C., or about 30° C. As used herein, the meaning of “ambient conditions” can include temperatures of about room temperature, relative humidity of from about 20% to about 100%, and barometric pressure of from about 975 millibar (mbar) to about 1050 mbar. For example, relative humidity can be about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99%, about 100%, or anywhere in between. For example, barometric pressure can be about 975 mbar, about 980 mbar, about 985 mbar, about 990 mbar, about 995 mbar, about 1000 mbar, about 1005 mbar, about 1010 mbar, about 1015 mbar, about 1020 mbar, about 1025 mbar, about 1030 mbar, about 1035 mbar, about 1040 mbar, about 1045 mbar, about 1050 mbar, or anywhere in between.

All ranges disclosed herein are to be understood to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, e.g., 5.5 to 10. Unless stated otherwise, the expression “up to” when referring to the compositional amount of an element means that element is optional and includes a zero percent composition of that particular element. Unless stated otherwise, all compositional percentages are in weight percent (wt. %).

As used herein, the meaning of “a,” “an,” and “the” includes singular and plural references unless the context clearly dictates otherwise.

In the following examples, aluminum alloy products and their components may be described in terms of their elemental composition in weight percent (wt. %). In each alloy, the remainder is aluminum, with a maximum wt. % of 0.15% for the sum of all impurities.

Incidental elements, such as grain refiners and deoxidizers, or other additives may be present in the alloys described herein and may add other characteristics on their own without departing from or significantly altering the alloy described herein or the characteristics of the alloy described herein.

Unavoidable impurities, including materials or elements may be present in an alloy in minor amounts due to inherent properties of aluminum or leaching from contact with processing equipment. Some alloys, as described, may contain no more than about 0.25 wt. % of any element besides the alloying elements, incidental elements, and unavoidable impurities.

### Methods of Producing the Alloys and Alloy Products

The alloy products described herein can be prepare using suitable methods. For example, aluminum alloys may be cast, homogenized, hot-rolled, cold-rolled, heat treated, formed, or the like to generate aluminum alloy products.

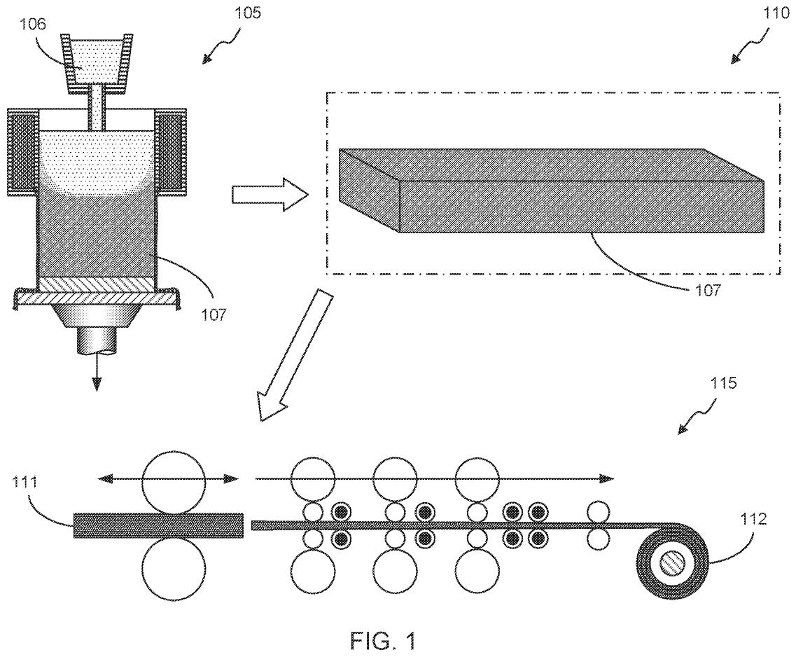

FIG. 1 provides an overview of an example method of making an aluminum alloy product. Although FIG. 1 is described below for preparing aluminum alloy products, it will be appreciated the disclosed methods are useful for preparing composite, multiphase metal products, as described herein, such as where the molten alloy used in the casting process comprises an aluminum and an additional metal (e.g., silicon, tin, indium, gallium, antimony, lead, nickel, copper, zinc, carbon, germanium, silver, magnesium, manganese, bismuth, or a conductive element having a lithium alloying potential higher than, similar to, or about equal to that of aluminum). During casting of such a mixture of materials, multiple phases may be formed, such as a first phase (e.g., high aluminum phase) primarily comprising aluminum or an aluminum alloy and a second phase (e.g., a low aluminum phase) primarily comprising the conductive element or an alloy thereof.

The method of FIG. 1 begins at 105, where an aluminum alloy 106 is cast to form a cast aluminum alloy product 107, such as an ingot or other cast product. At 110, the cast aluminum alloy product 107 is homogenized to form a homogenized aluminum alloy product 111. At 115, the homogenized aluminum alloy product 111 is subjected to one or more hot rolling passes and/or one or more cold rolling passes to form a rolled aluminum alloy product 112, which may correspond to an aluminum alloy article, such as an aluminum alloy plate, an aluminum alloy shate, or an aluminum alloy sheet. Optionally, the rolled aluminum alloy product 112 is subjected to additional processing steps, as described below, to form an aluminum alloy article.

Non-limiting examples of casting processes include a direct chill (DC) casting process or a continuous casting (CC) process. For example, FIG. 1 depicts a schematic illustration of a DC casting process at 105, but other casting processes can be used. A continuous casting system can include a pair of moving opposed casting surfaces (e.g., moving opposed belts, rolls or blocks), a casting cavity between the pair of moving opposed casting surfaces, and a molten metal injector. The molten metal injector can have an end opening from which molten metal can exit the molten metal injector and be injected into the casting cavity.

A cast aluminum alloy product, such as a cast ingot, cast slab, or other cast product, can be processed by any desirable techniques. Optionally, the processing steps can be used to prepare rolled aluminum alloy products, such as aluminum alloy sheets. Example optional processing steps include, but are not limited to, homogenization, hot rolling, cold rolling, annealing, solution heat treatment, and pre-aging.

In a homogenization step, a cast product may be heated to a temperature ranging from about 400° C. to about 600° C. For example, the cast product can be heated to a temperature of about 400° C., about 410° C., about 420° C., about 430° C., about 440° C., about 450° C., about 460° C., about 470° C., about 480° C., about 490° C., about 500° C., about 510° C., about 520° C., about 530° C., about 540° C., about 550° C., about 560° C., about 570° C., about 580° C., about 590° C., or about 600° C. The product may then be allowed to soak (i.e., held at the indicated temperature) for a period of time to form a homogenized product. In some examples, the total time for the homogenization step, including the heating and soaking phases, can be up to 24 hours. For example, the product can be heated up to 500° C. to 600° C., and soaked, for a total time of up to 18 hours for the homogenization step. Optionally, the product can be heated to below 490° C. and soaked, for a total time of greater than 18 hours for the homogenization step. In some cases, the homogenization step comprises multiple processes. In some non-limiting examples, the homogenization step includes heating a cast product to a first temperature for a first period of time followed by heating to a second temperature for a second period of time. For example, a cast product can be heated to about 465° C. for about 3.5 hours and then heated to about 480° C. for about 6 hours.

Following a homogenization step, a hot rolling step can be optionally performed. Prior to the start of hot rolling, the homogenized product can be allowed to cool to a temperature between 300° C. to 450° C. For example, the homogenized product can be allowed to cool to a temperature of between 325° C. to 425° C. or from 350° C. to 400° C. The homogenized product can then be hot rolled at a temperature between 300° C. to 450° C. to form a hot rolled plate, a hot rolled shate or a hot rolled sheet having a gauge between 3 mm and 200 mm (e.g., 3 mm, 4 mm, 5 mm, 6 mm, 7 mm, 8 mm, 9 mm, 10 mm, 15 mm, 20 mm, 25 mm, 30 mm, 35 mm, 40 mm, 45 mm, 50 mm, 55 mm, 60 mm, 65 mm, 70 mm, 75 mm, 80 mm, 85 mm, 90 mm, 95 mm, 100 mm, 110 mm, 120 mm, 130 mm, 140 mm, 150 mm, 160 mm, 170 mm, 180 mm, 190 mm, 200 mm, or anywhere in between).

Optionally, the cast product can be a continuously cast product that can be allowed to cool to a temperature between 300° C. to 450° C. For example, the continuously cast product can be allowed to cool to a temperature of between 325° C. to 425° C. or from 350° C. to 400° C. The continuously cast products can then be hot rolled at a temperature between 300° C. to 450° C. to form a hot rolled plate, a hot rolled shate or a hot rolled sheet having a gauge between 3 mm and 200 mm (e.g., 3 mm, 4 mm, 5 mm, 6 mm, 7 mm, 8 mm, 9 mm, 10 mm, 15 mm, 20 mm, 25 mm, 30 mm, 35 mm, 40 mm, 45 mm, 50 mm, 55 mm, 60 mm, 65 mm, 70 mm, 75 mm, 80 mm, 85 mm, 90 mm, 95 mm, 100 mm, 110 mm, 120 mm, 130 mm, 140 mm, 150 mm, 160 mm, 170 mm, 180 mm, 190 mm, 200 mm, or anywhere in between). During hot rolling, temperatures and other operating parameters can be controlled so that the temperature of the hot rolled intermediate product upon exit from the hot rolling mill is no more than 470° C., no more than 450° C., no more than 440° C., or no more than 430° C.

Cast, homogenized, or hot-rolled products can be optionally cold rolled using cold rolling mills into thinner products, such as a cold rolled sheet. The cold rolled product can have a gauge between about 0.5 to 10 mm, e.g., between about 0.7 to 6.5 mm. Optionally, the cold rolled product can have a gauge of 0.5 mm, 1.0 mm, 1.5 mm, 2.0 mm, 2.5 mm, 3.0 mm, 3.5 mm, 4.0 mm, 4.5 mm, 5.0 mm, 5.5 mm, 6.0 mm, 6.5 mm, 7.0 mm, 7.5 mm, 8.0 mm, 8.5 mm, 9.0 mm, 9.5 mm, or 10.0 mm. The cold rolling can be performed to result in a final gauge thickness that represents a gauge reduction of up to 85% (e.g., up to 10%, up to 20%, up to 30%, up to 40%, up to 50%, up to 60%, up to 70%, up to 80%, or up to 85% reduction) as compared to a gauge prior to the start of cold rolling. Optionally, an interannealing step can be performed during the cold rolling step, such as where a first cold rolling process is applied, followed by an annealing process (interannealing), followed by a second cold rolling process. The interannealing step can be performed at a temperature of from about 300° C. to about 450° C. (e.g., about 310° C., about 320° C., about 330° C., about 340° C., about 350° C., about 360° C., about 370° C., about 380° C., about 390° C., about 400° C., about 410° C., about 420° C., about 430° C., about 440° C., or about 450° C.). In some cases, the interannealing step comprises multiple processes. In some non-limiting examples, the interannealing step includes heating the partially cold rolled product to a first temperature for a first period of time followed by heating to a second temperature for a second period of time. For example, the partially cold rolled product can be heated to about 410° C. for about 1 hour and then heated to about 330° C. for about 2 hours.

Subsequently, a cast, homogenized, or rolled product can optionally undergo a solution heat treatment step. The solution heat treatment step can be any suitable treatment for the product that results in solutionizing of soluble particles. The cast, homogenized, or rolled product can be heated to a peak metal temperature (PMT) of up to 590° C. (e.g., from 400° c. to 590° C.) and soaked for a period of time at the PMT to form a hot product. For example, the cast, homogenized, or rolled product can be soaked at 480° C. for a soak time of up to 30 minutes (e.g., 0 seconds, 60 seconds, 75 seconds, 90 seconds, 5 minutes, 10 minutes, 20 minutes, 25 minutes, or 30 minutes). After heating and soaking, the hot product is rapidly cooled at rates greater than 200 ° C./s to a temperature between 500 and 200° C. to form a heat-treated product. In one example, the hot product is cooled at a quench rate of above 200° C./second at temperatures between 450° C. and 200° C. Optionally, the cooling rates can be faster in other cases. Optionally, the temperature can be lower in other cases. In one example, the hot product is cooled at a quench rate of above 200° C./second at temperatures between 450° C. and 200° C.

After quenching, the heat-treated product can optionally undergo a pre-aging treatment by reheating before coiling. The pre-aging treatment can be performed at a temperature of from about 70° C. to about 125° C. for a period of time of up to 6 hours. For example, the pre-aging treatment can be performed at a temperature of about 70° C., about 75° C., about 80° C., about 85° C., about 90° C., about 95° C., about 100° C., about 105° C., about 110° C., about 115° C., about 120° C., or about 125° C. Optionally, the pre-aging treatment can be performed for about 30 minutes, about 1 hour, about 2 hours, about 3 hours, about 4 hours, about 5 hours, or about 6 hours. The pre-aging treatment can be carried out by passing the heat-treated product through a heating device, such as a device that emits radiant heat, convective heat, induction heat, infrared heat, or the like.

The cast products described herein can be used to make products in the form of sheets, plates, foils, or other suitable products. For example, plates including the products as described herein can be prepared by processing an ingot in a homogenization step or casting a product in a continuous caster followed by a hot rolling step. In the hot rolling step, the cast product can be hot rolled to a 200 mm thick gauge or less (e.g., from about 10 mm to about 200 mm). For example, the cast product can be hot rolled to a plate having a final gauge thickness of about 10 mm to about 175 mm, about 15 mm to about 150 mm, about 20 mm to about 125 mm, about 25 mm to about 100 mm, about 30 mm to about 75 mm, or about 35 mm to about 50 mm. In some cases, plates may be rolled into thinner metal products, such as sheets. In certain embodiments, the cast products described herein can be used to make foils through techniques such as rolling, electroplating, or other suitable processing techniques.

### Example Metals and Metal Alloys

Described herein are methods of preparing, and using, metals and metal alloys, including aluminum, aluminum alloys, multiphase aluminum-based composites, others, and the resultant treated metals and metal alloys. In some examples, the metals for use in the methods described herein include aluminum alloys, for example, 1xxx series aluminum alloys, 2xxx series aluminum alloys, 3xxx series aluminum alloys, 4xxx series aluminum alloys, 5xxx series aluminum alloys, 6xxx series aluminum alloys, 7xxx series aluminum alloys, or 8xxx series aluminum alloys. In some examples, the materials for use in the methods described herein include non-ferrous materials, including aluminum, aluminum alloys, magnesium, magnesium-based materials, magnesium alloys, magnesium composites, titanium, titanium-based materials, titanium alloys, copper, copper-based materials, composites, sheets used in composites, or any other suitable metal, non-metal or combination of materials. Monolithic as well as non-monolithic, such as roll-bonded materials, cladded alloys, clad layers, composite materials, such as but not limited to carbon fiber-containing materials, or various other materials are also useful with the methods described herein. In some examples, aluminum alloys containing iron are useful with the methods described herein. In some examples, the metals and metal alloys comprise aluminum and one or more of silicon, tin, indium, gallium, antimony, lead, nickel, copper, zinc, carbon, germanium, silver, magnesium, manganese, bismuth, or other conductive element having a lithium alloying potential higher than, similar to, or about equal to that of aluminum.

By way of non-limiting example, exemplary 1xxx series aluminum alloys for use in the methods described herein can include AA1100, AA1100A, AA1200, AA1200A, AA1300, AA1110, AA1120, AA1230, AA1230A, AA1235, AA1435, AA1145, AA1345, AA1445, AA1150, AA1350, AA1350A, AA1450, AA1370, AA1275, AA1185, AA1285, AA1385, AA1188, AA1190, AA1290, AA1193, AA1198, or AA1199.

Non-limiting exemplary 2xxx series aluminum alloys for use in the methods described herein can include AA2001, AA2002, AA2004, AA2005, AA2006, AA2007, AA2007A, AA2007B, AA2008, AA2009, AA2010, AA2011, AA2011A, AA2111, AA2111A, AA2111B, AA2012, AA2013, AA2014, AA2014A, AA2214, AA2015, AA2016, AA2017, AA2017A, AA2117, AA2018, AA2218, AA2618, AA2618A, AA2219, AA2319, AA2419, AA2519, AA2021, AA2022, AA2023, AA2024, AA2024A, AA2124, AA2224, AA2224A, AA2324, AA2424, AA2524, AA2624, AA2724, AA2824, AA2025, AA2026, AA2027, AA2028, AA2028A, AA2028B, AA2028C, AA2029, AA2030, AA2031, AA2032, AA2034, AA2036, AA2037, AA2038, AA2039, AA2139, AA2040, AA2041, AA2044, AA2045, AA2050, AA2055, AA2056, AA2060, AA2065, AA2070, AA2076, AA2090, AA2091, AA2094, AA2095, AA2195, AA2295, AA2196, AA2296, AA2097, AA2197, AA2297, AA2397, AA2098, AA2198, AA2099, or AA2199.

Non-limiting exemplary 3xxx series aluminum alloys for use in the methods described herein can include AA3002, AA3102, AA3003, AA3103, AA3103A, AA3103B, AA3203, AA3403, AA3004, AA3004A, AA3104, AA3204, AA3304, AA3005, AA3005A, AA3105, AA3105A, AA3105B, AA3007, AA3107, AA3207, AA3207A, AA3307, AA3009, AA3010, AA3110, AA3011, AA3012, AA3012A, AA3013, AA3014, AA3015, AA3016, AA3017, AA3019, AA3020, AA3021, AA3025, AA3026, AA3030, AA3130, or AA3065.

Non-limiting exemplary 4xxx series aluminum alloys for use in the methods described herein can include AA4004, AA4104, AA4006, AA4007, AA4008, AA4009, AA4010, AA4013, AA4014, AA4015, AA4015A, AA4115, AA4016, AA4017, AA4018, AA4019, AA4020, AA4021, AA4026, AA4032, AA4043, AA4043A, AA4143, AA4343, AA4643, AA4943, AA4044, AA4045, AA4145, AA4145A, AA4046, AA4047, AA4047A, or AA4147.

Non-limiting exemplary 5xxx series aluminum alloys for use in the methods described herein product can include AA5182, AA5183, AA5005, AA5005A, AA5205, AA5305, AA5505, AA5605, AA5006, AA5106, AA5010, AA5110, AA5110A, AA5210, AA5310, AA5016, AA5017, AA5018, AA5018A, AA5019, AA5019A, AA5119, AA5119A, AA5021, AA5022, AA5023, AA5024, AA5026, AA5027, AA5028, AA5040, AA5140, AA5041, AA5042, AA5043, AA5049, AA5149, AA5249, AA5349, AA5449, AA5449A, AA5050, AA5050A, AA5050C, AA5150, AA5051, AA5051A, AA5151, AA5251, AA5251A, AA5351, AA5451, AA5052, AA5252, AA5352, AA5154, AA5154A, AA5154B, AA5154C, AA5254, AA5354, AA5454, AA5554, AA5654, AA5654A, AA5754, AA5854, AA5954, AA5056, AA5356, AA5356A, AA5456, AA5456A, AA5456B, AA5556, AA5556A, AA5556B, AA5556C, AA5257, AA5457, AA5557, AA5657, AA5058, AA5059, AA5070, AA5180, AA5180A, AA5082, AA5182, AA5083, AA5183, AA5183A, AA5283, AA5283A, AA5283B, AA5383, AA5483, AA5086, AA5186, AA5087, AA5187, or AA5088.

Non-limiting exemplary 6xxx series aluminum alloys for use in the methods described herein can include AA6101, AA6101A, AA6101B, AA6201, AA6201A, AA6401, AA6501, AA6002, AA6003, AA6103, AA6005, AA6005A, AA6005B, AA6005C, AA6105, AA6205, AA6305, AA6006, AA6106, AA6206, AA6306, AA6008, AA6009, AA6010, AA6110, AA6110A, AA6011, AA6111, AA6012, AA6012A, AA6013, AA6113, AA6014, AA6015, AA6016, AA6016A, AA6116, AA6018, AA6019, AA6020, AA6021, AA6022, AA6023, AA6024, AA6025, AA6026, AA6027, AA6028, AA6031, AA6032, AA6033, AA6040, AA6041, AA6042, AA6043, AA6151, AA6351, AA6351A, AA6451, AA6951, AA6053, AA6055, AA6056, AA6156, AA6060, AA6160, AA6260, AA6360, AA6460, AA6460B, AA6560, AA6660, AA6061, AA6061A, AA6261, AA6361, AA6162, AA6262, AA6262A, AA6063, AA6063A, AA6463, AA6463A, AA6763, AA6963, AA6064, AA6064A, AA6065, AA6066, AA6068, AA6069, AA6070, AA6081, AA6181, AA6181A, AA6082, AA6082A, AA6182, AA6091, or AA6092.

Non-limiting exemplary 7xxx series aluminum alloys for use in the methods described herein can include AA7011, AA7019, AA7020, AA7021, AA7039, AA7072, AA7075, AA7085, AA7108, AA7108A, AA7015, AA7017, AA7018, AA7019A, AA7024, AA7025, AA7028, AA7030, AA7031, AA7033, AA7035, AA7035A, AA7046, AA7046A, AA7003, AA7004, AA7005, AA7009, AA7010, AA7011, AA7012, AA7014, AA7016, AA7116, AA7122, AA7023, AA7026, AA7029, AA7129, AA7229, AA7032, AA7033, AA7034, AA7036, AA7136, AA7037, AA7040, AA7140, AA7041, AA7049, AA7049A, AA7149, AA7204, AA7249, AA7349, AA7449, AA7050, AA7050A, AA7150, AA7250, AA7055, AA7155, AA7255, AA7056, AA7060, AA7064, AA7065, AA7068, AA7168, AA7175, AA7475, AA7076, AA7178, AA7278, AA7278A, AA7081, AA7181, AA7185, AA7090, AA7093, AA7095, or AA7099.

Non-limiting exemplary 8xxx series aluminum alloys for use in the methods described herein can include AA8005, AA8006, AA8007, AA8008, AA8010, AA8011, AA8011A, AA8111, AA8211, AA8112, AA8014, AA8015, AA8016, AA8017, AA8018, AA8019, AA8021, AA8021A, AA8021B, AA8022, AA8023, AA8024, AA8025, AA8026, AA8030, AA8130, AA8040, AA8050, AA8150, AA8076, AA8076A, AA8176, AA8077, AA8177, AA8079, AA8090, AA8091, or AA8093.

### Methods of Using the Disclosed Alloy Products

The alloy products described herein can be used in battery applications. For example, the disclosed alloy products can be used as current collectors and/or electrode materials for batteries or electrochemical cells. Non-limiting examples of the battery applications include coin cells, pouch cells, cylindrical cells, or prismatic cells.

The alloy products and methods described herein can also be used in other electronics applications. For example, the alloy products and methods described herein can be used to prepare housings for electronic devices, including batteries. In some examples, the alloy products can be used to prepare housings for the outer casing of mobile phones (e.g., smart phones), tablet bottom chassis, single and multi-cell batteries, and other portable electronics.

As described above, solid-state electrochemical cells incorporating a solid-state electrolyte can advantageously incorporate aluminum materials as the anode active material. As an alloying electrode, aluminum can exhibit higher energy storage densities than commonly used anode materials for lithium-ion batteries, such as graphite, due to the higher storage capacity of aluminum for lithium than graphite. Although the storage capability of aluminum may not be as high as metallic lithium, aluminum alloying anodes do not suffer from dendrite formation in their normal mode of operation and thus provide safer operation of rechargeable or secondary batteries as compared to lithium metal batteries.

Additionally, avoiding use of graphite as the anode materials can not only increase anode storage capacity, but can limit the use of wet processing, since aluminum-based alloying anodes can be incorporated as a film or foil of material and do not have to be slurry deposited onto a current collector. In some cases, the aluminum-based alloying anodes can allow use as an anode material without a current collector, though conventional anode current collectors, such as copper foils, can also be used. In some cases, current collectors may comprise aluminum foils, such as an aluminum foil that is different from the active material of the anode. In some examples, protected aluminum foils can be used as an anode current collector, such as described in International Application Publication No. WO 2021/184035, hereby incorporated by reference. In examples in which the protected aluminum foils are used as the anode current collector, the protected aluminum foils can be produced through rolling, electroplating, or other suitable production techniques.

Incorporation of aluminum-based materials as the active material in a solid-state electrochemical cell can also allow for incorporation of recycled content material directly in the electrode of an electrochemical cell. For example, the anode active material of the solid-state electrochemical cells described herein can comprise aluminum alloys incorporating high amounts of recycled content, such as up to 10%, up to 20%, up to 30%, up to 40%, or more.

Use of solid-state electrolyte components can further enhance safety, manufacturability, and other characteristics of a battery system. Lithium-ion batteries generally incorporate liquid organic solvents in the electrolytes, such as carbonate solvents. Such solvents are generally flammable and undergo undesirable side reactions at surfaces of the anode active materials at the potentials involved. These side reactions can form a solid electrolyte interphase (SEI) layer that degrades performance and reduces capacity.

The use of liquid electrolytes together with aluminum-based active materials can exacerbate the formation of SEI layers, as aluminum-based active materials undergo volumetric changes when they uptake or release lithium ions. As the active materials uptake lithium, the active material expands, disturbing any SEI material on the surface of the active material and exposing fresh active material to the liquid electrolyte, which can undergo further reaction at the exposed active material and form additional SEI material. In this way, liquid electrolytes used with aluminum-based active materials can permit a buildup of SEI material above the active material. This excessive SEI growth can correspond to accelerated cell failure of electrochemical cells including liquid electrolyte with aluminum-based active materials.

However, when a solid-state electrolyte is used, such buildup of SEI material may not occur. For example, solid-state electrolytes may comprise solid materials, such as ceramic type sulfide materials like lithium argyrodite materials (e.g., Li₆PS₅Cl), oxide solid ion conductors, or polymer solid ion conductors, all of which do not flow like liquid electrolytes. When such solid-state electrolytes encounter volumetric expansion of the anode active material through uptake of lithium, the solid-state electrolyte cannot flow to enter cracks and interfaces of exposed fresh active material, limiting the formation of SEI materials. An interface material that may form or be positioned between an anode and the solid-state electrolyte can include SEI, an artificial solid-electrolyte interphase, a polymer coating, a carbon coating, or an inorganic coating.

A pressure can be applied between a solid-state electrolyte and an aluminum-based anode active material to ensure that good electrical and ionic communication is maintained during charging or discharging and to account for volumetric contraction or expansion by release or uptake of lithium atoms or ions. Such pressure can be applied as a stack pressure between the anode and the cathode, with the solid-state electrolyte between them. The stack pressure can be applied through a casing or other components. Example stack pressures may range from about 0.1 MPa to about 70 MPa, such as from 0.1 MPa to 1 MPa, from 1 MPa to 5 MPa, from 5 MPa to 10 MPa, from 10 MPa to 20 MPa, from 20 MPa to 30 MPa, from 30 MPa to 40 MPa, from 40 MPa to 50 MPa, from 50 MPa to 60 MPa, or from 60 MPa to 70 MPa.

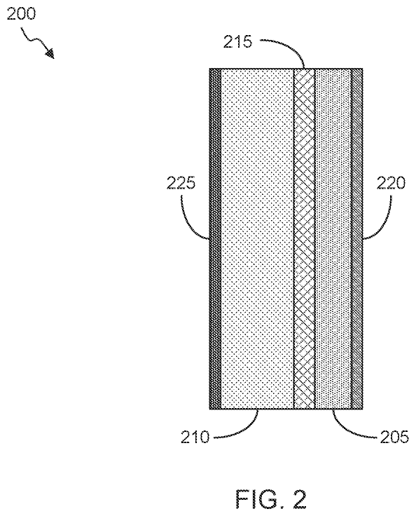

FIG. 2 provides a schematic illustration of an example solid-state electrochemical cell 200, comprising an anode active material 205, a cathode active material 210, a solid-state electrolyte 215, an anode current collector 220, and a cathode current collector 225. In examples, an anode current collector 220 is optional and is not present in some implementations herein. In conventional lithium-ion battery systems, the cathode current collector comprises a high purity aluminum foil, the cathode active material comprises a lithium metal oxide, a porous non-conductive material soaked with a liquid electrolyte comprising an organic solvent and a lithium salt is positioned between the anode active material and the cathode active material, the anode active material comprises graphite, and the anode current collector comprises copper foil. Certain of these materials may be used with the solid-state electrochemical cell, but others may not be used, such as a liquid electrolyte. Interface materials are not explicitly shown in FIG. 2, but one or more interface materials may be present between the anode active material 205 and the solid-state electrolyte 215 and/or the solid-state electrolyte and the cathode active material 210.

For example, the cathode active material 210 and cathode current collector 225 may incorporate materials used in conventional battery systems. Optionally, the cathode current collector 225 may comprise aluminum, such as in the form of an aluminum alloy foil. In some cases, cathode current collector 225 may comprise a high purity aluminum alloy, such as comprising 99.00 wt. % Al or more. Use of high-purity aluminum alloys is useful for maintaining the electrical conductivity of the cathode current collector 225 at as high a level as possible. In some examples, cathode current collector 225 may comprise recycled content, such as at least 1% recycled content, at least 10% recycled content, at least 20% recycled content, at least 30% recycled content, or at least 40% recycled content. The cathode active material 210 may comprise any suitable cathode active material including but not limited to, alkali metal host materials (e.g., a lithium host material) or alkali metal-transition metal oxide cathode active materials, such as lithium nickel manganese cobalt oxide, lithium nickel cobalt aluminum oxide, lithium manganese oxide, lithium iron phosphate, or lithium metal cobalt oxide. Additional examples of the suitable cathode active material can include a conversion cathode, lithiated FeS₂, lithiated FeF₃, or sulfur.

The anode active material 205 may comprise a lithium alloying anode, for example. Lithium can alloy with aluminum at potentials encountered at the anode, where lithium ions can be reduced and incorporated into the bulk of the aluminum material as an alloy during charging. During discharging, lithium can be oxidized and released from an alkali metal alloying anode as lithium ions. Lithium can also alloy with other metals or conductive elements at potentials encountered at the anode; when such other metals or conductive elements are also present with aluminum, it may be desirable that other metals or conductive elements alloy with lithium before aluminum alloys with lithium. The aluminum used for the anode active material 205 can be a foil, such as a foil that comprises aluminum or an aluminum alloy, as a composite metal foil, such as comprising one or more other metals or semiconductors like silicon, tin, indium, gallium, antimony, lead, nickel, copper, zinc, carbon, germanium, silver, magnesium, manganese, bismuth, or the like, in amounts up to about 50 at %, such as from 0.01 at % to 0.05 at %, from 0.05 at % to 0.1 at %, from 0.1 at % to 0.5 at %, from 0.5 at % to 1 at %, from 1 at % to 2 at %, from 2 at % to 3 at %, from 3 at % to 4 at %, from 4 at % to 5 at %, from 5 at % to 6 at %, from 6 at % to 7 at %, from 7 at % to 8 at %, from 8 at % to 9 at %, from 9 at % to 10 at %, from 10 at % to 11 at %, from 11 at% to 12 at%, from 12 at % to 13 at %, from 13 at % to 14 at %, from 14 at % to 15 at %, from 15 at % to 16 at %, from 16 at % to 17 at %, from 17 at % to 18 at %, from 18 at % to 19 at %, from 19 at % to 20 at %, from 20 at % to 30 at %, from 30 at % to 40 at %, from 40 at % to 50 at %, or greater than 50 at %, with the remainder of the composite metal foil being aluminum or an aluminum alloy.

In some examples, the lithiated form of the other metal or conductive element can exhibit a lithium ion diffusivity or diffusion coefficient that is greater than lithiated aluminum or aluminum alloys. The other metal or conductive element can optionally be present as a plurality of individual domains within the aluminum, such as having a cross-sectional dimension of less than 5 μm or less than 1 μm, for example. The other metal or conductive element can provide highly conductive lithium ion pathways, allowing rapid transportation of lithium ions throughout the anode active material 205, supporting high charging and discharging rate performance, for example. In some examples, the anode active material 205, or a phase thereof, may exhibit a lithium ion diffusion coefficient of from about 10⁻⁵ cm² s⁻¹ to about 10⁻¹⁰ cm² s⁻¹ or greater, such as from 10⁻⁵ cm² s⁻¹ to 5×10⁻⁵ cm² s⁻¹, from 5×10⁻⁵ cm² s⁻¹ to 10⁻⁶ cm² s⁻¹, from 10⁻⁶ cm² s⁻¹ to 5×10^{×6} cm² s⁻¹, from 5×10⁻⁶ cm² s⁻¹ to 10⁻⁷ cm² s⁻¹, from 10⁻⁷ cm² s⁻¹ to 5×10⁻⁷ cm² s⁻¹, from 5×10⁻⁷ cm² s⁻¹ to 10⁻⁸ cm² s⁻¹ from 10⁻⁸ cm² s⁻¹ to 5×10⁻⁸ cm² s⁻¹, from 5×10⁻⁸ cm² s⁻¹ to 10⁻⁹ cm² s⁻¹, from 10⁻⁹ cm² s⁻¹ to 5×10⁻⁹ cm² s⁻¹, or from 5×10⁻⁹ cm² s⁻¹ to 10⁻¹⁰ cm² s⁻¹.

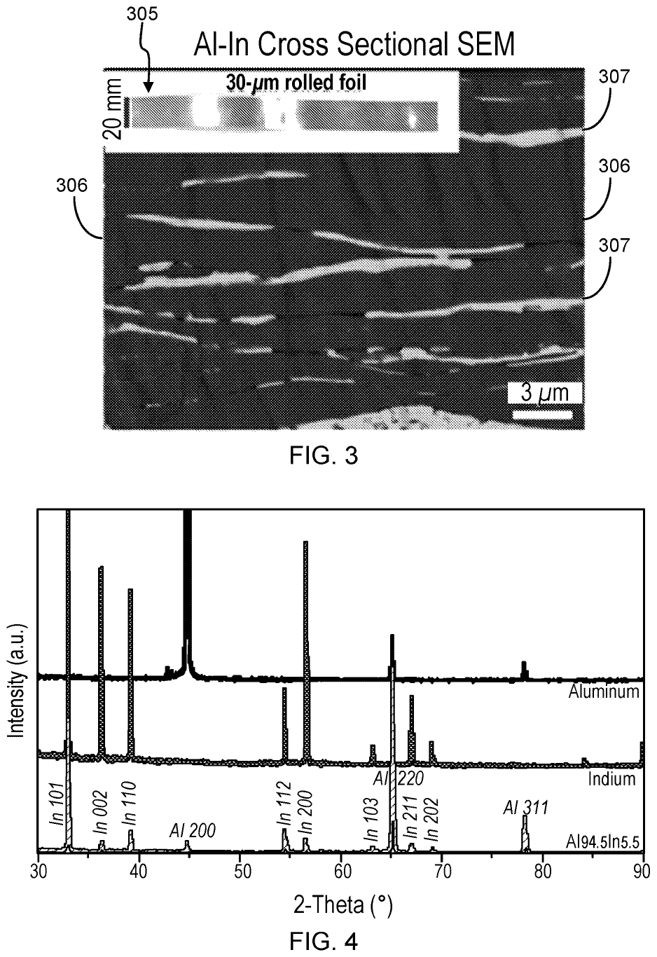

The inset in FIG. 3 shows a photograph of an example anode active material 305, here depicted as an aluminum-based multi-component product (foil) comprising 94.5 at % aluminum and 5.5 at % indium, having a thickness of approximately 30 μm, and generated by a casting and rolling process, as described herein. FIG. 3 also provides a cross-sectional backscattered electron micrograph image of the anode active material 305. The cross-sectional backscattered electron micrograph image shows a plurality of different domains or phases in the anode active material 305, including aluminum dominant domains 306 (darker regions) and indium dominant domains 307 (lighter regions). Here, the indium dominant domains 307 are dispersed throughout the aluminum dominant domains 306.

As described herein, foils useful as anode active materials or current collectors can be processed using metal casting and rolling processes, but other techniques can be used to prepare foils including powder-based sintering or laser melting processes, such as laser powder bed fusion techniques. The anode active material 205 may exhibit a specific capacity of from about 300 mAh/g to about 1000 mAh/g or more, such as from 300 mAh/g to 400 mAh/g, from 400 mAh/g to 500 mAh/g, from 500 mAh/g to 600 mAh/g, from 600 mAh/g to 700 mAh/g, from 700 mAh/g to 800 mAh/g, from 800 mAh/g to 900 mAh/g, or from 900 mAh/g to 1000 mAh/g. In some examples, the specific capacity may be higher still, such as if other components with higher specific capacities are included in the anode active material, such as silicon.

The anode active material 205 may comprise aluminum alloys or multi-component systems, such as eutectic alloys, solid solution alloys, mixed metal systems, multiphase metal systems, or composite particle systems. In some examples, anode active material 205 may comprise a multi-component foil comprising aluminum and one or more of silicon, tin, indium, gallium, antimony, lead, nickel, copper, carbon, germanium, zinc, magnesium, manganese, bismuth, or silver. Additional details on aluminum-based multi-component foils may be found in U.S. Provisional Application No. 63/362,722, filed on Apr. 8, 2022, hereby incorporated by reference. In some examples, anode active material 205 may comprise a composite including a first plurality of aluminum or aluminum alloy particles and a second plurality of particles selected from at least one of metal particles or non-metal particles. Additional details on composite anodes may be found in U.S. Application No. 63/261,216, filed on Sep. 15, 2021, and PCT International Application No. PCT/US 2022/076169, filed on Sep. 9, 2022, hereby incorporated by reference.

The anode current collector 220 may comprise any suitable material, such as copper or other conductive materials, like aluminum. Copper can be beneficial for use as anode current collector 220, as copper is non-reactive at the potentials involved in lithium battery systems and exhibits high electrical conductivity. Aluminum can alloy with lithium at the potentials involved, making it useful as the anode active material 205, but such characteristics may not be desirable for use of aluminum as anode current collector 220. In some examples, however, aluminum may be used as anode current collector 220, as aluminum is also a highly conductive material and can be constructed as a foil. Optionally, when anode active material 205 comprises a metal foil, anode current collector 220 may not be used, as electrical connections can instead be established directly with anode active material 205 to provide conduction of electrons to/from external circuits (e.g., a load or a power supply). In some cases, aluminum may be used as anode current collector 220 in the form of a protected aluminum or aluminum alloy foil.

Anode current collector 220 may also be made to have an engineered structure. By engineering the structure, the structure may include additional space and micro-porosity. Without being bound by theory, such additional space and/or micro-porosity may compensate for volume changes within the anode current collector 220. Various methods may be used to form this engineered structure, including powder metallurgy, forming a micro-porous or nano-porous structure by additive manufacturing, using metallic foams, forming perforations by laser or deep etching, de-alloying (e.g., chemical de-alloying), or other methods. In some examples, an engineered structure may be processed by rolling, such as to at least partially consolidate or otherwise make a foil from the engineered structure. In some examples, an engineered structure may comprise or be coupled to, joined to, or bonded to a solid aluminum-based or aluminum alloy-based structure (e.g., a foil) as a solid base layer. In some examples, an engineered structure may be coupled to, joined to, or bonded to a current collector, for example a foil-based current collector, such as a copper current collector or a protected or coated aluminum or aluminum alloy current collector (e.g., an aluminum or aluminum foil coated with Fe, TiN, Ni, or the like). Examples of aluminum-based current collectors, including protected or coated aluminum current collectors, are described in PCT International Application No. PCT/US2021/070250, which is hereby incorporated by reference.

Any suitable solid-state electrolyte 215 may be used in solid-state electrochemical cell 200. For example, solid-state electrolyte 215 may comprise an ion-conducting and electrically insulating material, such as an inorganic solid electrolyte. In some cases, solid-state electrolyte 215 may comprise a polymer solid electrolyte, a composite polymer electrolyte, a gel-polymer electrolyte, or a gel electrolyte, though in some examples, the solid-state electrolyte 215 explicitly comprises an inorganic solid electrolyte and not a solid polymer electrolyte, composite polymer electrolyte, or gel electrolyte. Inorganic solid electrolytes include, but are not limited to, crystalline, glassy, or ceramic ion conducting materials (e.g., alkali metal ion conducting materials). Example solid-state electrolytes include, but are not limited to those comprising one or more of lithium super ionic conductors (LISICON), lithium argyrodite materials, (e.g., Li₆PS₅Cl), doped garnet materials, (e.g., Li₇La₃Zr₂O₁₂, LLZO), Li₁₀GeP₂S₁₂ and related materials, such as Li₁₀SnP₂S₁₂, lithium phosphorus sulfide (e.g., Li₃PS₄), halide materials (e.g., Li₃YCl₆), or lithium phosphorus oxynitride (LIPON). Suitable materials for solid-state electrolyte 215 may exhibit an ionic conductivity for alkali metal ions of greater than or about 10⁻⁴ S/cm (e.g., from 10⁻⁴ S/cm to 0.01 S/cm).

Solid-state electrochemical cell 200 may be constructed in any suitable configuration, such as a cylindrical or spiral wound configuration, a prismatic or pouch configuration, a coin-cell configuration, etc. Solid-state electrochemical cell 200 may be subjected to repeated charging and discharging (e.g., cycling), for any desirable or possible number of cycles.

The components of solid-state electrochemical cell 200 can have any suitable dimensions, depending on the application. In examples, the anode active material 205 may have a thickness of from about 2 μm to 60 μm, such as from 2 μm to 5 μm, from 5 μm to 10 μm, from 10 μm to 15 μm, from 15 μm to 20 μm, from 20 μm to 25 μm, from 25 μm to 30 μm, from 30 μm to 35 μm, from 35 μm to 40 μm, from 40 μm to 45 μm, from 45 μm to 50 μm, from 50 μm to 55 μm, or from 55 μm to 60 μm. In some examples, the anode active material 205 may exhibit a change in thickness or volume upon charging or discharging, due to the uptake or release of lithium ions. In some examples, a thickness increases in the anode active material 205 upon charging/lithium ion uptake may be offset by a thickness decrease in the anode active material 205 upon discharge/lithium ion release. In some examples, the thickness of the anode active material 205 may change by up to about 100% after cycling for one or more charge/discharge cycles. For example, the anode active material 205 may exhibit a change in thickness of less than or about 100%, less than or about 90%, less than or about 80%, less than or about 70%, less than or about 60%, less than or about 50%, less than or about 40%, less than or about 30%, less than or about 20%, less than or about 10%, or less than or about 5%, after cycling for one or more charge/discharge cycles, such as 5 charge/discharge cycles, 10 charge/discharge cycles, 20 charge/discharge cycles, 30 charge/discharge cycles, 40 charge/discharge cycles, 50 charge/discharge cycles, 60 charge/discharge cycles, 70 charge/discharge cycles, 80 charge/discharge cycles, 90 charge/discharge cycles, 100 charge/discharge cycles, 200 charge/discharge cycles, 300 charge/discharge cycles, 400 charge/discharge cycles, 500 charge/discharge cycles, or more.

In examples, the solid-state electrolyte 215 may have a thickness of from about 10 μm to 300 μm, such as from 10 μm to 50 μm, from 50 μm to 100 μm, from 100 μm to 200 μm, or from 200 μm to 300 μm.

Methods are also provided for making solid-state batteries. An example method may comprise providing an anode or anode active material, providing a cathode, and positioning a solid-state electrolyte between the anode or anode active material and the cathode. Examples of useful anodes, anode active materials, cathodes, and solid electrolytes are described herein. In one example, an anode or anode active material may comprise a composite foil as described herein, such as comprising a first metal phase comprising aluminum or an aluminum alloy, for example comprising or representing from about 50 at % to about 99 at % of the composite foil, and a second metal phase interspersed with the first metal phase, such as a second metal phase comprising a conductive element that comprises or represents from 1 at % to 50 at % of the composite foil.

The examples disclosed herein will serve to further illustrate aspects of the invention without, at the same time, however, constituting any limitation thereof. On the contrary, it is to be clearly understood that resort may be had to various embodiments, modifications and equivalents thereof which, after reading the description herein, may suggest themselves to those skilled in the art without departing from the spirit of the invention. The examples and embodiments described herein may also make use of conventional procedures, unless otherwise stated. Some of the procedures are described herein for illustrative purposes.

### EXAMPLE

This Example describes details of comparative testing of electrochemical cells. The electrochemical cells include solid-state electrochemical cells incorporating aluminum anode active material and a solid-state electrolyte, the aluminum anode active material including two metal phases. A first set of comparative cells includes solid-state electrochemical cells incorporating high-purity aluminum foil as an anode and the solid-state electrolyte. A second set of comparative cells includes liquid-electrolyte electrochemical cells incorporating the aluminum anode active material or the high-purity aluminum foil as the anode.

Solid-state electrochemical cells were prepared using an aluminum alloy-based anode and a composite cathode including lithium nickel manganese cobalt oxide active material of formula LiNi_{0.6}Mn_{0.2}Co_{0.2}O₂ (NMC-622). The aluminum alloy-based anode was prepared using an aluminum-based multi-component product created by melting stoichiometric ratios of aluminum and indium at 800° C. in an inert environment followed by natural cooling. For example, the stoichiometric ratios can include 94.5 atomic (at) % of aluminum and 5.5 at % of indium. This is just one example, and any other suitable ratios may be used, as described elsewhere in this disclosure. The aluminum-based multi-component product then was rolled to a desired thickness of approximately 30 μm thick, depicted in FIG. 3 as an inset image, resulting in the aluminum alloy-based anode being approximately 1 cm in diameter. The thickness of the aluminum alloy-based anodes corresponds to an areal capacity of approximately 8 mAh cm⁻² in a fully lithiated state, enabling commercially relevant capacities of approximately 2-5 mAh cm⁻² while retaining unreacted aluminum in the aluminum alloy-based anodes. This unreacted aluminum in the aluminum alloy-based anodes can be used as a current collector for the solid-state electrochemical cells. The aluminum alloy-based anodes can exhibit an electrical conductivity of about 10% IACS to 70% IACS. As a first reference cell, a high-purity aluminum anode of a similar thickness and diameter was assembled into a solid-state electrochemical cell using an identical composite cathode.

The composite cathode was prepared using the lithium nickel manganese cobalt oxide active material, Li₆PS₅Cl, and vapor grown carbon fiber. The lithium nickel manganese cobalt oxide active material was protected using a coating of LiNb_{0.5}Ta_{0.5}O₃ to prevent side reactions with the Li₆PS₅Cl. A cathode loading for the cathode was approximately 5.8 mAh cm⁻². A Li₆PS₅Cl solid electrolyte was positioned between the cathode and the anode.

As a separator layer, Li₆PS₅Cl with approximately 1 μm particle size was used. Specifically, approximately 90 mg was uniaxially pressed at 125 MPa inside a 10 mm diameter polyether ether ketone (PEEK) die, forming the separator layer with a thickness of approximately 0.7 mm. The aluminum alloy-based anode of 30 um thickness and predetermined amounts of powder to create the composite cathode were added before pressing the solid-state electrochemical cell to 375 MPa. Subsequently, 1 cm diameter graphite disks were added on opposite ends of the solid-state electrochemical cell to ensure even pressure distribution across the solid-state electrochemical cell. The titanium plungers then were reinserted to press the solid-state electrochemical cell between the two graphite disks. Using a custom pressure cell, the solid-state electrochemical cell was placed under a predetermined stack pressure, the custom pressure cell maintaining an operating pressure by locking the solid-state electrochemical cell between two steel plates with bolts at each corner. The stack pressure was controlled to be between 15 and 70 MPa through precise tightening of the bolts with a digital torque wrench.

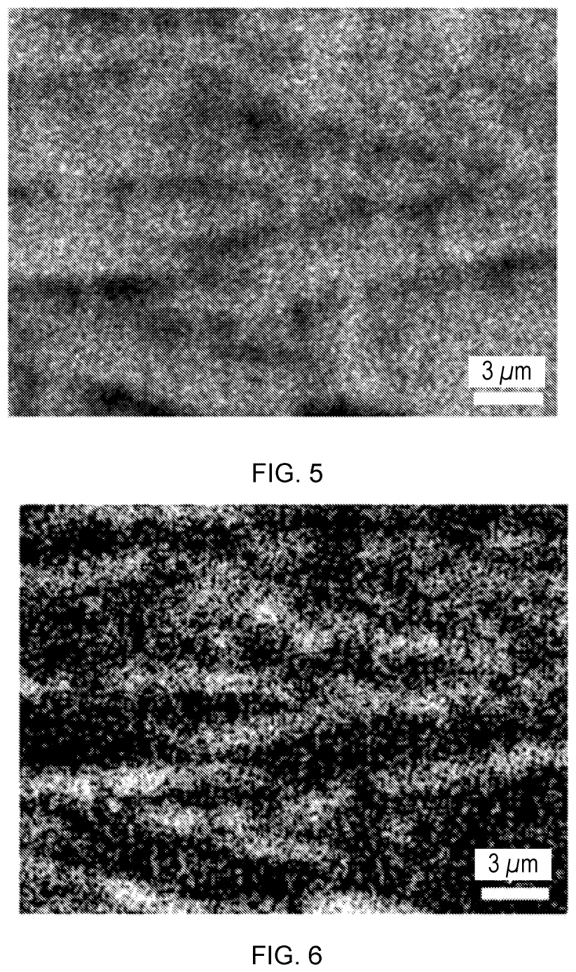

X-ray diffraction (XRD) experiments were performed, revealing that the aluminum alloy-based anode comprised individual domains of indium with aluminum, as depicted in FIG. 4. XRD data was collected with scans from 30° to 90° with Cu anode as the X-ray source, 45 keV tension, 50 mA current, and copper K-α radiation. These separate domains or phases are consistent with solid-phase immiscibility during monotectic cooling from an Al—In phase diagram. FIG. 3 depicts a cross-sectional scanning electron microscopy (SEM) image of a pristine 30-μm thick aluminum alloy-based anode with 5.5 atomic % indium. SEM images were collected using an accelerating voltage of 15 kV and an 8 mm working distance. FIG. 5 and FIG. 6 depict X-ray energy dispersive spectroscopy (EDS) analysis revealing elemental distribution in the aluminum alloy-based anode, where a mass ratio of indium to aluminum in the aluminum alloy-based anode was verified to be approximately 1:4. EDS was performed using the same accelerating voltage and working distance of 15 kV and 8 mm, respectively. FIG. 5 depicts an EDS analysis for aluminum distribution in the aluminum alloy-based anode, and FIG. 6 depicts an EDS analysis for indium distribution in the aluminum alloy-based anode. The aluminum alloy-based anode exhibits a distinctive laminar microstructure, with indium layers distributed throughout the aluminum matrix. In comparison, the high-purity aluminum anode was dense without cross-sectional morphological features.

A first set of solid-state cells was cycled first at C/40 for two cycles, then at C/20 for three cycles, and then at C/10 for the remainder of the cycles. Specifically, the first set of solid-state cells was cycled first at a current density of 0.2 mA cm⁻² for two cycles, then at 0.4 mA cm⁻² for three cycles, and then at 0.8 mA cm⁻² for the remainder of the cycles. A stack pressure of approximately 24 MPa was applied to the first set of solid-state cells.

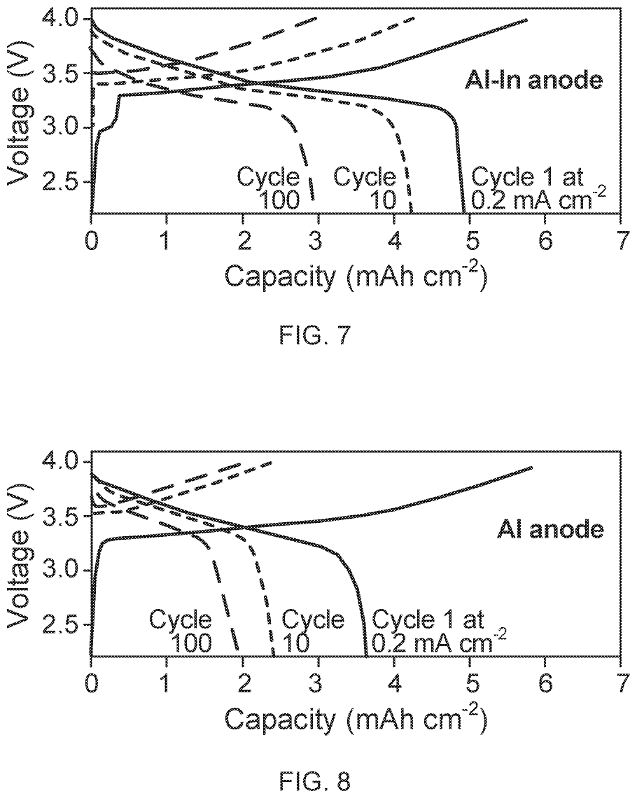

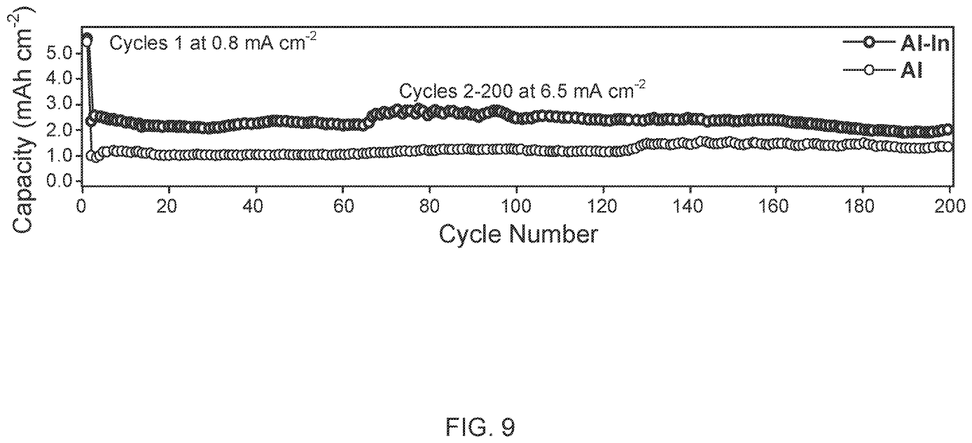

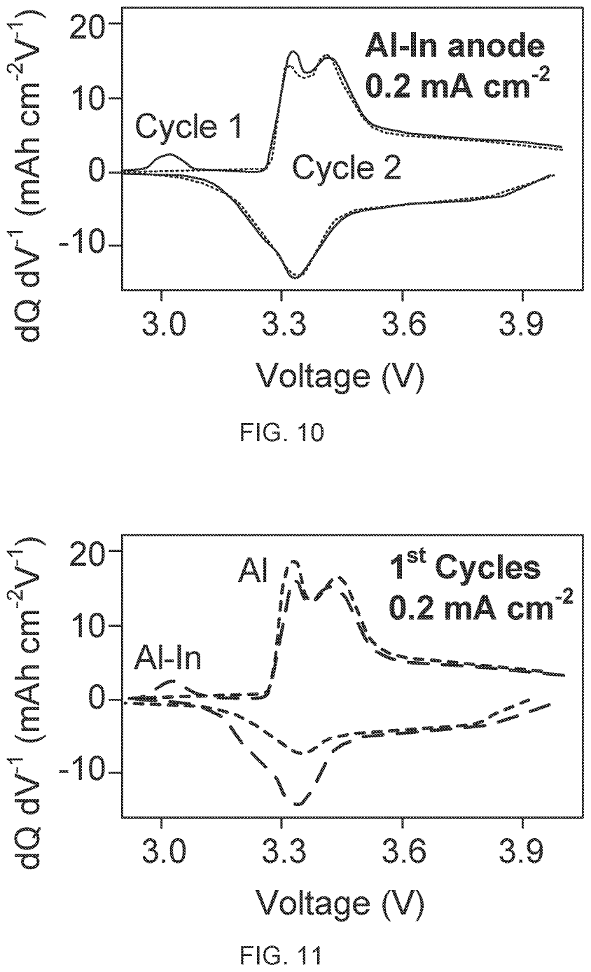

Voltage vs. capacity curves for the 1^{st}, 10^{th}, and 100^{th} cycles are shown for a first example solid-state electrochemical cell in FIG. 7 and for the first reference cell in FIG. 8. For both the first example solid-state electrochemical cell and the first reference cell, almost the entire cathode capacity was utilized on a first charge at 0.2 mA cm⁻². Additionally, as depicted in FIG. 7, the first example solid-state electrochemical cell showed an initial shoulder during charge associated with lithiation of indium. Plots of capacity vs. cycle number are shown for the first example solid-state electrochemical cell and the first reference cell in FIG. 9. A first set of differential capacity (dQ/dV) curves are shown in FIG. 10 and were calculated by linearly interpolating data and taking a first derivative before applying a Savitzky-Golay smoothing filter. The curves shown in FIG. 7 and FIG. 10 show little evidence of further lithiation of indium after a first cycle of galvanostatic cycling, indicating that indium within the aluminum alloy-based anode remains lithiated even after discharge. A second set of differential capacity curves are shown in FIG. 11, comparing a first cycle of two cells with different anodes to highlight improved reversibility of the example solid-state electrochemical cell.

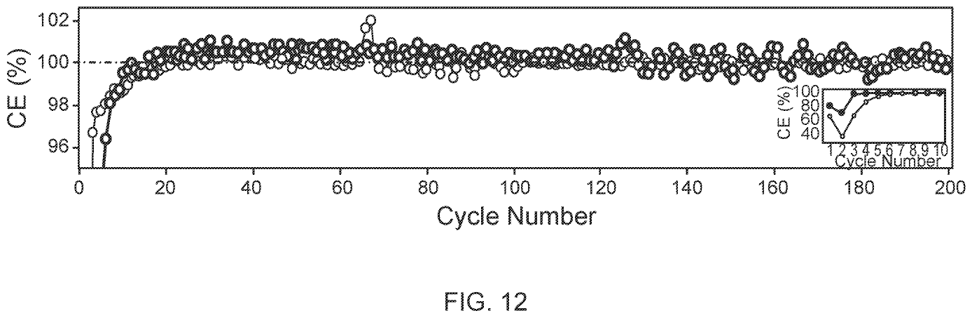

Plots of Coulombic efficiency vs. cycle number are shown for the first example solid-state electrochemical cell and the first reference cell in FIG. 12. As depicted in an inset plot of FIG. 12, the first example solid-state electrochemical cell showed an initial Coulombic efficiency (ICE) for the first cycle of 85%. The first reference cell showed an initial Coulombic efficiency (ICE) for the first cycle of approximately 64%. Coulombic efficiency for the first example solid-state electrochemical cell increased to above 99% over the first few cycles and maintained an average of 99.68% from the fifth cycle to the last cycle. In comparison, Coulombic efficiency for the first reference cell exhibits erratic behavior, for example showing Coulombic efficiency values over 100%, which can indicate lithium trapping.

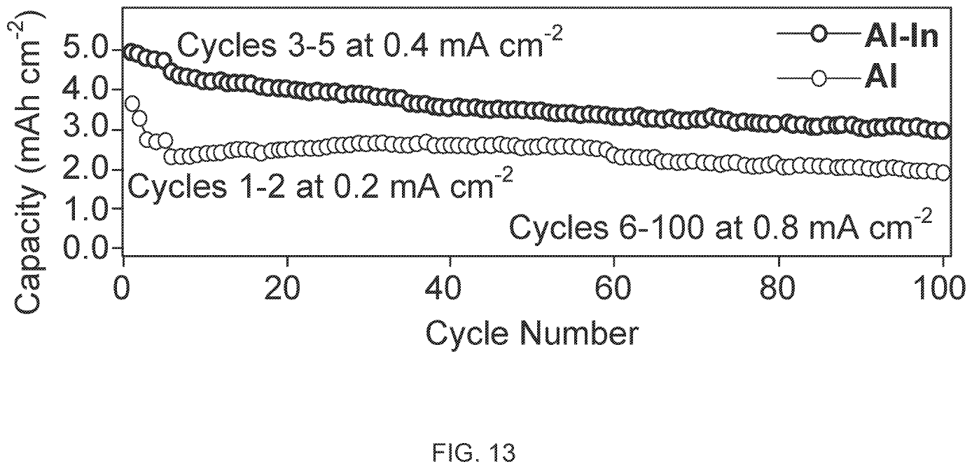

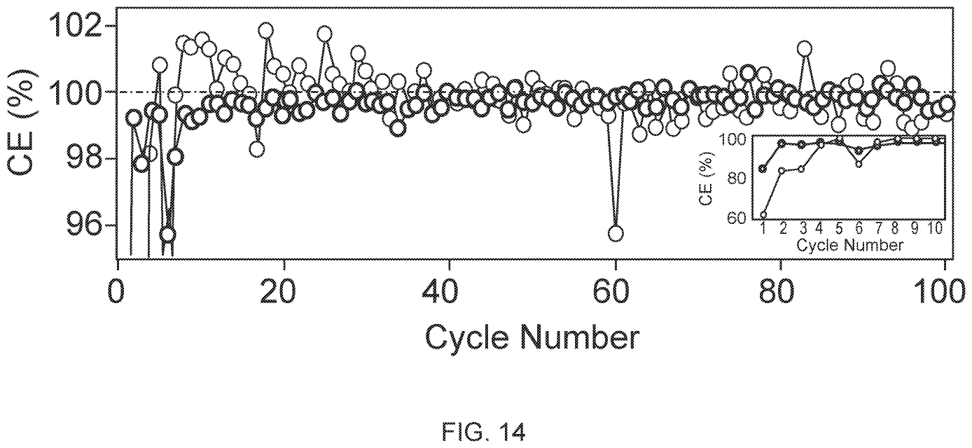

After the first two cycles of the first set of solid-state cells, the current density was increased to 0.4 mA cm⁻² for three cycles and then to 0.8 mA cm⁻² until completion of 100 cycles. FIG. 13 and FIG. 14 depict a corresponding plot of areal capacity vs. cycle number and another corresponding plot of Coulombic efficiency vs. cycle number, respectively. The first set of solid-state cells exhibited relatively stable cycling with some decay under these cycling conditions, with little evidence of short circuiting. The first example solid-state electrochemical cell showed notably higher areal capacity than the first reference cell, 3-4 mAh cm⁻² vs. 2-3 mAh cm⁻², as depicted in FIG. 13. The Coulombic efficiency values for the first set of solid-state cells rapidly increased to above 99% over the first few cycles, and the first example solid-state electrochemical cell exhibited an average Coulombic efficiency of 99.68% from cycle 5 through cycle 100. The first reference cell showed relatively erratic Coulombic efficiency values with some values over 100%, which is likely a result of trapped lithium within the high-purity aluminum anode.

Electrochemical performance and stability of the first example solid-state electrochemical cell approaches that of an electrochemical cell with a pure indium foil anode with similar thickness, which exhibited an initial Coulombic efficiency of 86% and relatively stable cycling for hundreds of cycles. Thus, including small amounts of indium within aluminum foils improves cycling capacity, Coulombic efficiency, and stability.

A second example solid-state electrochemical cell with a higher cathode loading of 8.3 mAh cm⁻² was tested. This second example solid-state electrochemical cell underwent galvanostatic testing using an increased current density of 6.5 mA cm⁻² with 50 MPa of stack pressure. The second reference cell was tested under similar conditions as a comparative cell. This second set of solid-state cells was cycled first at a lower current density of 0.8 mA cm⁻² for one cycle and then a higher current density of 6.5 mA cm⁻² for the remainder of the cycles.

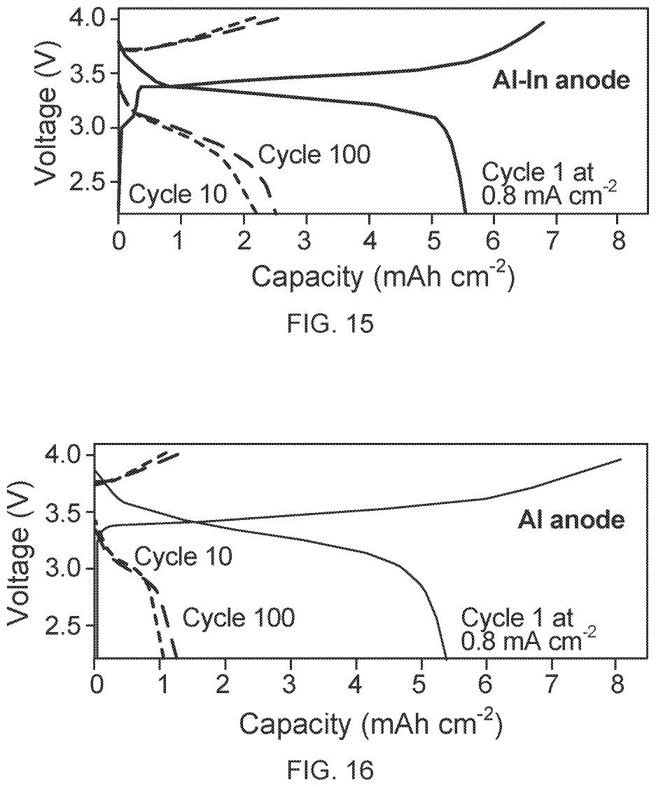

Voltage vs. capacity curves for the 1^{st}, 2^{nd}, and 10^{th} cycles are shown for the second example solid-state electrochemical cell in FIG. 15 and for the second reference cell in FIG. 16. Plots of capacity vs. cycle number are shown for the second example solid-state electrochemical cell and the second reference cell in FIG. 9. Plots of Coulombic efficiency vs. cycle number are shown for the second example solid-state electrochemical cell and the second reference cell in FIG. 12. During a first charge, almost a full volume of each anode was lithiated (approximately 7-8 mAh cm⁻²), and the second example solid-state electrochemical cell exhibited higher initial Coulombic efficiency at 82% compared to the second reference cell. Both the second example solid-state electrochemical cell and the second reference cell exhibited relatively stable cycling at the increased current density during cycle 2 through cycle 200, as depicted in FIG. 9 and FIG. 12. The second example solid-state electrochemical showed particularly stable Coulombic efficiency, with an average Columbic efficiency of 99.98% from cycle 5 to cycle 200. Lower areal capacities in FIG. 9 than in FIG. 13 are due to the increased current density. This rate capability is notable when compared to solid-state cells using lithium metal anodes, which often cannot sustain current densities greater than a few milliamperes per cm² due to rapid filament growth and short circuiting. Thus, this demonstrates a distinct benefit of engineered alloy foils over lithium metal for solid-state cells.

These cycling results of the first set of solid-state cells and the second set of solid-state cells demonstrate improved stability compared to electrochemical cycling of identical foils in conventional liquid-electrolyte coin cells, such as the second set of comparative cells. This is likely due to enhanced interfacial stability and reduced SEI growth. The second set of comparative cells were prepared using anode material punched into disks with a diameter of 12 mm placed into CR 2032 coin cells. Metallic lithium chips were used as a counter electrode to the anode material, and porous polymer films were used as separators. 50 μL of liquid electrolyte was used; the liquid electrolyte including 1.0 M LiPF₆ in ethylene carbonate/diethyl carbonate (EC/DEC, 1:1 by volume) with 10 vol % fluoroethylene carbonate (FEC).

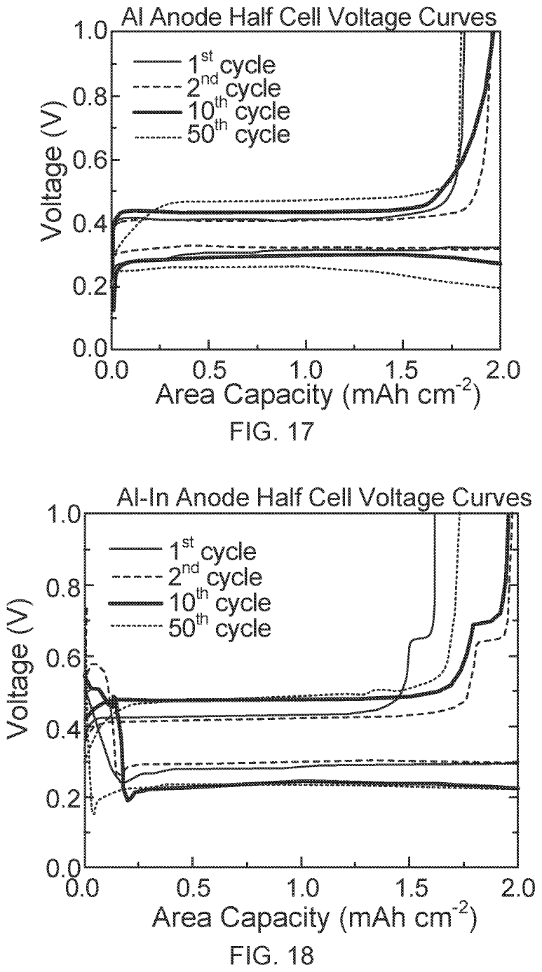

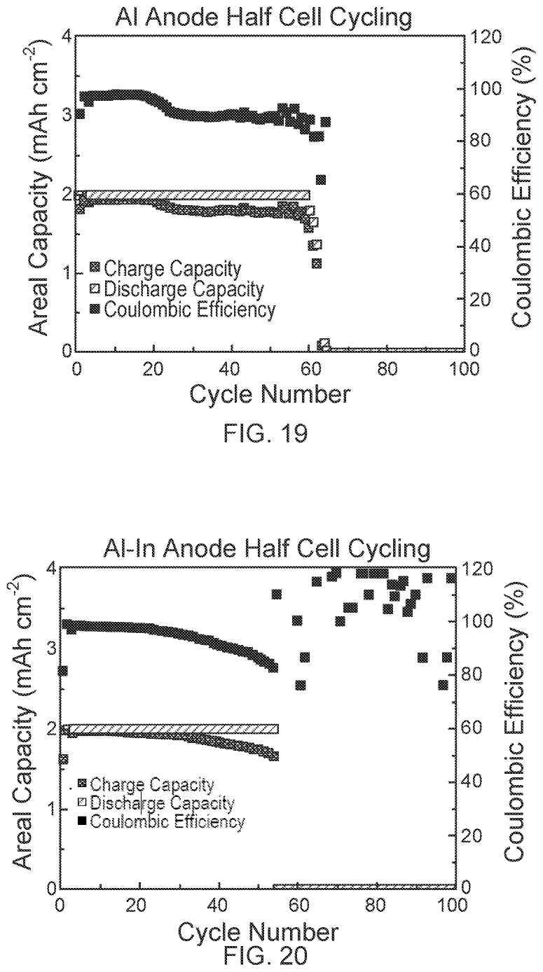

The second set of comparative cells were tested with a voltage range of 0.01 V to 1.0 V. First two cycles of galvanostatic charge-discharge testing featured a lower current density of 0.2 mA cm⁻² before cycling at 1 mA cm⁻². FIG. 17, FIG. 18, FIG. 19, and FIG. 20 show galvanostatic cycling data from the second set of comparative cells cycled with a controlled areal capacity of 2.0 mAh cm⁻² per cycle in half cells using a typical carbonate-based liquid electrolyte. Specifically, FIG. 17 and FIG. 18 depict voltage vs. areal capacity curves for a first half cell with the high-purity aluminum anode and a second half cell with the aluminum alloy-based anode, respectively. FIG. 19 and FIG. 20 depict plots of areal capacity vs. cycle number for the first half cell with the high-purity aluminum anode and the second half cell with the aluminum alloy-based anode, respectively. The second set of comparative cells failed catastrophically in less than 70 cycles, as depicted in FIG. 19 and FIG. 20. This result is typical and is due to excessive SEI growth caused by internal pore formation within the anodes during alloying/dealloying.

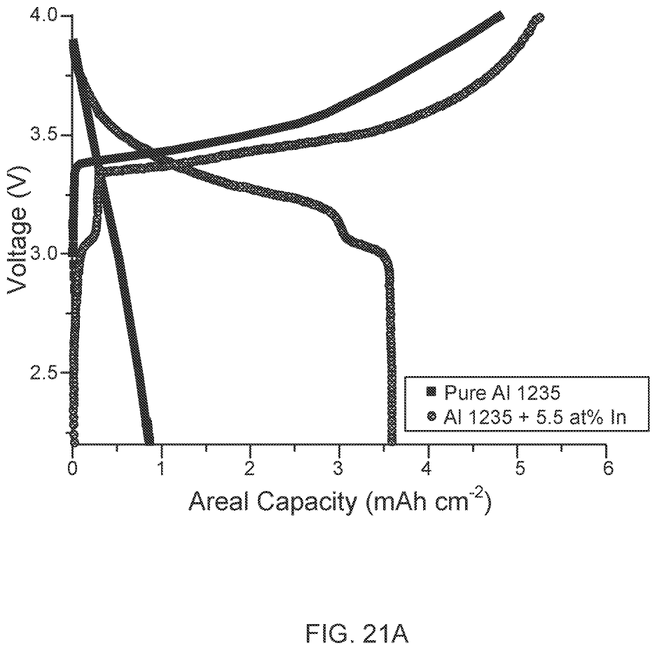

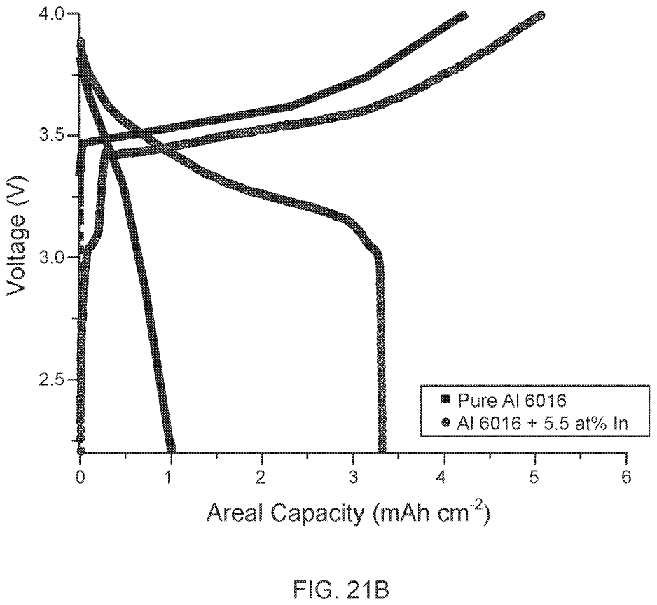

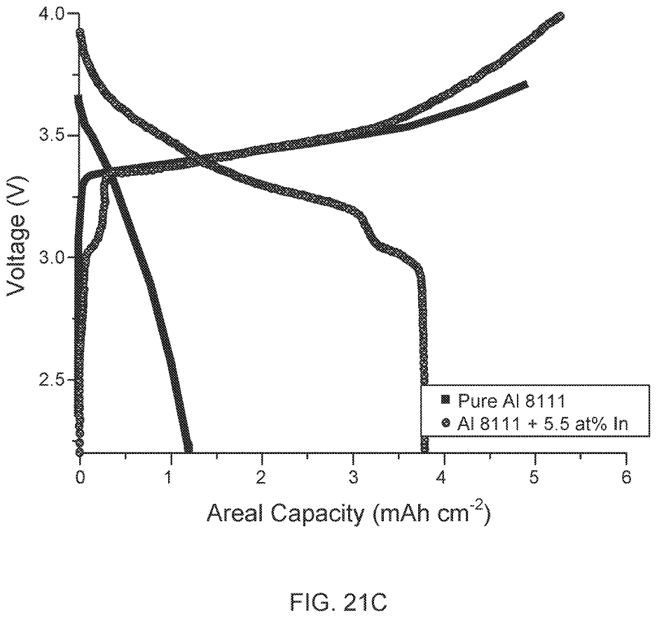

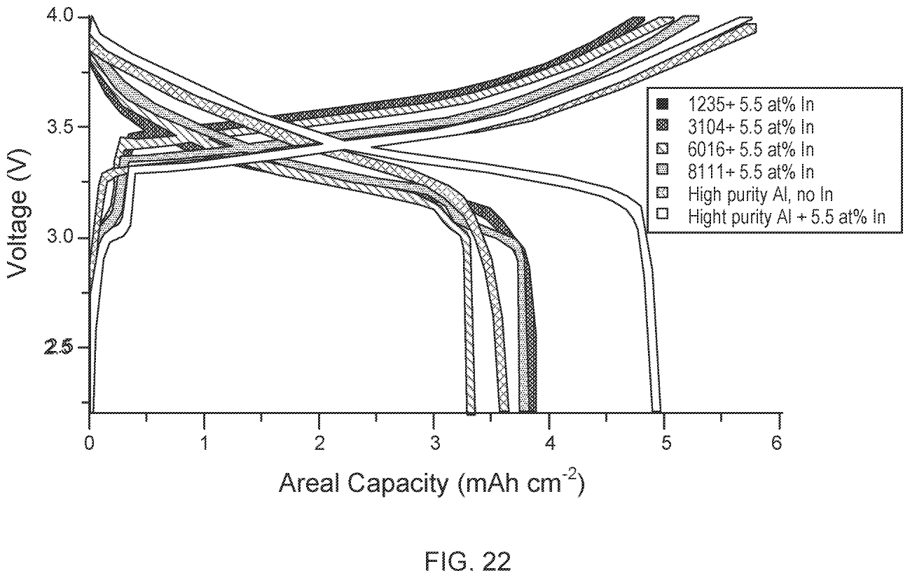

A third set of solid-state cells including an aluminum-based composite foil as the anode active material as described herein was tested to compare to a third set of reference cells including aluminum foil as the anode active material. Charge and discharge curves are provided in FIG. 21A, FIG. 21B, and FIG. 21C. The third set of solid-state cells includes three example solid-state cells that were each prepared using a respective anode with a different aluminum alloy for the aluminum-based composite foil. In particular, the example solid-state cells were respectively prepared using an anode foil including 94.5 at % AA1235 and 5.5 at % indium, 94.5 at % AA6016 and 5.5 at % indium, and 94.5 at % AA8111 and 5.5 at % indium. As shown in FIGS. 21A, 21B, and 21C, the example solid-state cells including the aluminum-based composite foil exhibited higher areal capacity compared to the reference cells including a respective aluminum alloy as the anode active material. FIG. 22 shows a plot of charge and discharge curves corresponding to example electrochemical cells including the aluminum-based composite foil as the anode and a comparative electrochemical cell including a high-purity aluminum foil as the anode active material. As shown in FIG. 22, an example electrochemical cell having an aluminum-based composite foil prepared by combining a high-purity aluminum alloy with indium exhibited the highest areal capacity of the example electrochemical cells shown in FIG. 22. In particular, through comparing the example electrochemical cell and the comparative electrochemical cell, data shown in FIG. 22 indicate that incorporating another element, such as indium, to form a metal phase interspersed with the high-purity aluminum alloy can increase areal capacity.

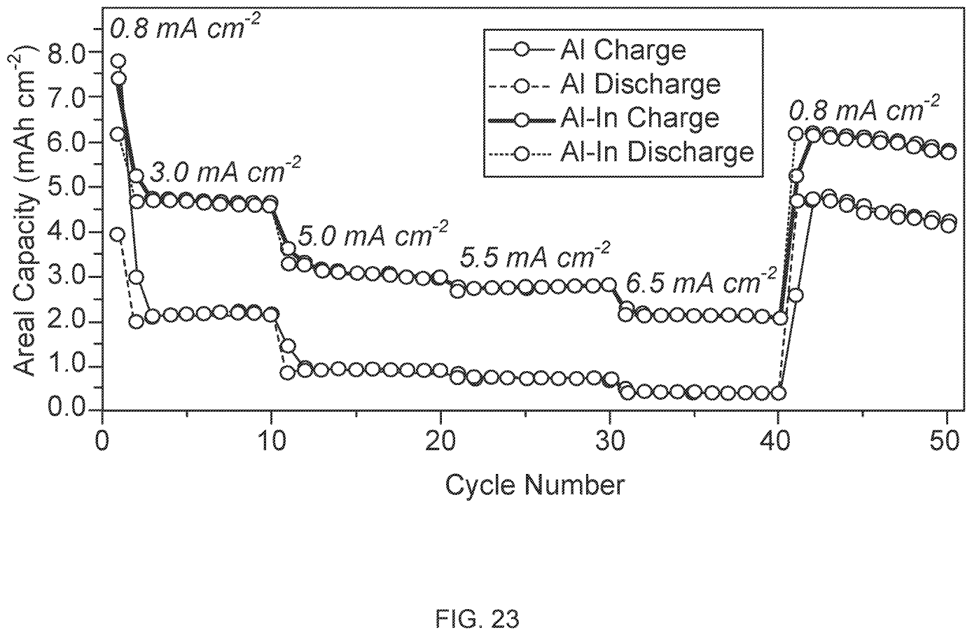

FIG. 23 shows electrochemical rate testing experiments in which another set of two solid-state cells were subjected to increasing current densities, the other set of solid-state cells including one solid-state cell with the aluminum alloy-based anode and another solid-state cell with the high-purity aluminum anode. The electrochemical rate testing demonstrates that the aluminum alloy-based anode shows better rate capability than the high-purity aluminum anode. Consistently higher areal capacities were achieved with the aluminum alloy-based anode at current densities up to 6.5 mA cm⁻² under identical cell fabrication and testing conditions. Cycling of greater than 2 mAh cm⁻² areal capacity at a current density of 6.5 mA cm⁻² indicates that the solid-state cell with the aluminum alloy-based anode can exhibit relatively fast charge/discharge, although the solid-state cell is not optimized for fast rates.

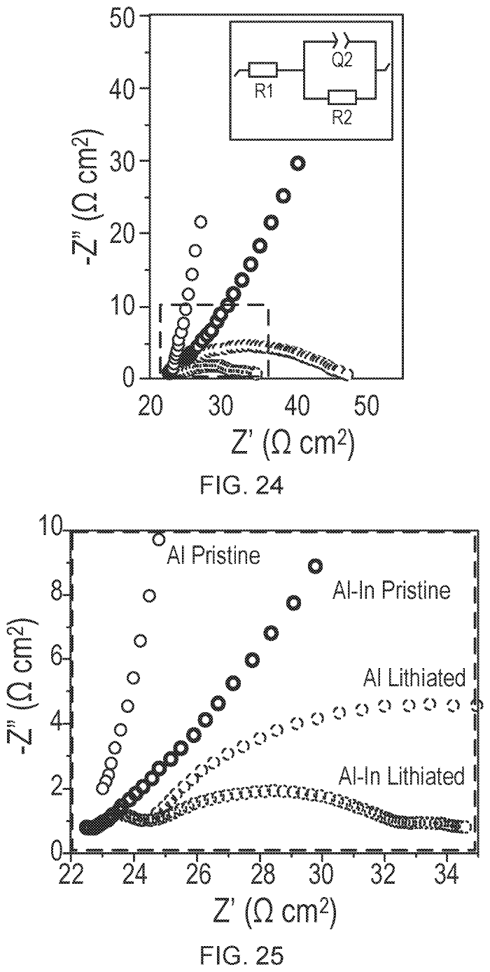

Electrochemical impedance spectroscopy (EIS) was carried out before and after charge of full cells, as depicted in FIG. 24. A subsection of FIG. 24 is shown in greater detail in FIG. 25. EIS was performed using a voltage amplitude of 10 mV between 2 MHz and 2 Hz with 10 points per decade. The spectra from full cells with both types of anodes in a pristine state show blocking behavior with extended Warburg tails, while depressed semicircles are present after charge. A charged cell with the aluminum alloy-based anode shows a higher-frequency depressed semicircle with a width of approximately 10.3 Ωcm² extracted via fit with an equivalent circuit shown in an inset image of FIG. 24, along with an additional low-frequency feature. Another charged cell with the high-purity aluminum anode shows a larger depressed semicircle with a width of approximately 25.1 Ωcm². These data suggest that the presence of indium reduces interfacial resistance of an anode interface.

Experiments using galvanostatic intermittent titration technique (GITT) were used to investigate an influence of indium addition on transport processes. In this technique, current pulses are followed by rest periods, and voltage relaxation during rest provides insight into diffusion processes in the active material. Solid-state half cells with lithium metal counter electrodes were used to avoid effects of the composite cathode on voltage relaxation. A separator layer for the solid-state half cells was fabricated by pressing 90 mg of Li₆PS₅Cl at 250 MPa inside a PEEK die via titanium plungers. Then, an anode foil was added as a working electrode before pressing to 375 MPa. A 1 cm diameter graphite disk was added on top of the anode foil, and a 1 cm diameter lithium metal disk (approximately 13 mg and 0.3 mm thick) was added to an opposite end onto an exposed solid electrolyte. The solid-state half cells were tested under a stack pressure of 10 MPa.

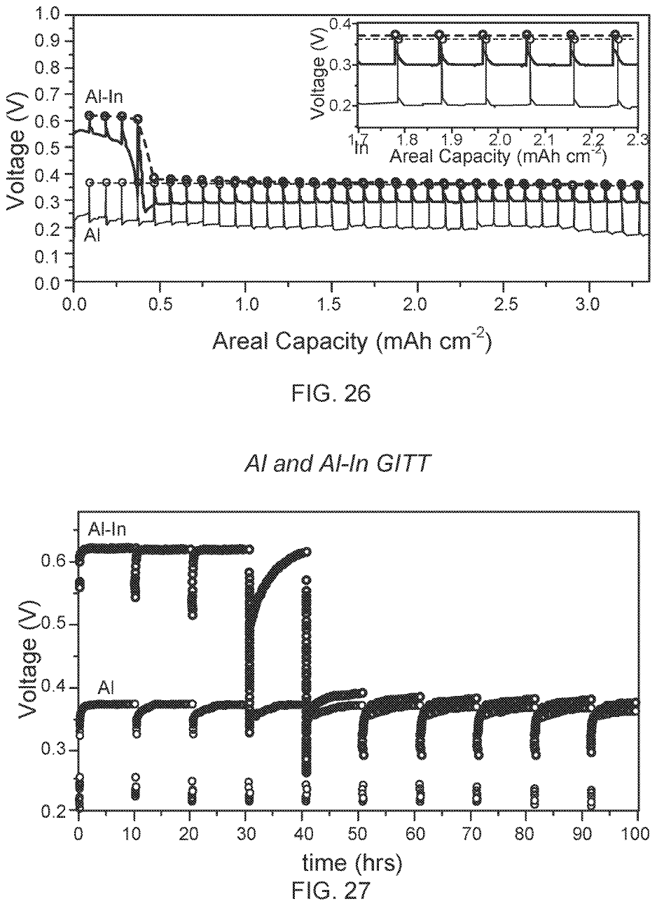

FIG. 26 shows GITT data for two solid-state half cells, a first half cell with the high-purity aluminum anode and a second half cell with the aluminum alloy-based anode. The first half cell and the second half cell were assembled using Li metal as the counter electrode and a Li₆PS₅Cl pellet as the SSE. A current of 0.4 mA was used for 10 minutes, followed by 10-hour rest periods. FIG. 27 shows voltage traces vs. time in hours for solid-state half cells with a lithium metal counter electrode at 10 MPa.

As shown in FIG. 26, the first half cell shows slightly decreasing voltage over the current pulses, with an open-circuit voltage (OCV) relaxing to a constant value of approximately 0.36 V after each rest. The second half cell shows a relatively higher plateau and OCV of approximately 0.62 V over a first approximately 0.37 mAh cm⁻², which corresponds to a lithiation of indium to Li_{x≤1}In. An areal capacity for indium lithiation within the 30-μm aluminum alloy-based anode would be approximately 0.36 mAh cm⁻² assuming a theoretical capacity of 194 mAh g⁻¹ for a Li—In phase, which suggests that Li_{0.9<x<1}In forms during the first lithiation. After lithiation of indium, voltage during the current pulses then drops to a constant value of approximately 0.30 V during aluminum lithiation, with the OCV relaxing to approximately 0.37 V. These data show that the indium and aluminum in the aluminum alloy-based anode are lithiated sequentially in accord with their distinct voltage plateaus despite being physically intermixed.

The aluminum alloy-based anode in FIG. 26 shows approximately 100 mV lower overpotential during aluminum lithiation compared to the high-purity aluminum anode, while both anodes show almost the same OCV values. This observation arises from an interspersed Li-In phase enabling relatively fast lithium diffusion throughout the aluminum alloy-based anode, minimizing a contribution of mass transport to overpotential. The lithium diffusion coefficient of the aluminum alloy-based anode can range from about 10⁻⁵ cm² s⁻¹ to 10⁻¹⁰ cm² s⁻¹. These data show that a design concept of interspersed mixed-ion-electron-conducting “Li highways” within a dense foil proves to be effective for high-rate cycling. Rate testing data is shown in FIG. 23. The entrained LiIn phase likely also helps minimize lithium trapping by providing transport channels for lithium removal during discharge, enabling the relatively high initial Coulombic efficiency observed in the aluminum alloy-based anode solid-state full cells.

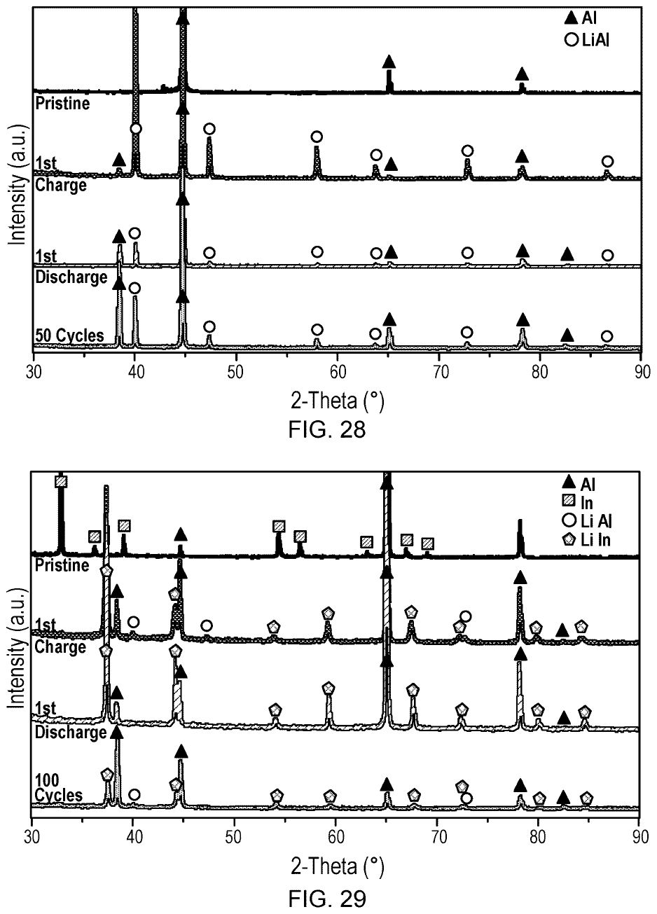

Experiments were performed to characterize foil evolution within solid-state cells to further understand structural and morphological origins of the improved cycling performance. Ex situ X-ray diffraction (XRD) analysis was used to characterize a structural evolution of aluminum and aluminum alloy-based anodes throughout cycling. As shown in FIG. 28, a pristine aluminum foil (ICDD 04-012-7848) was lithiated to form β-LiAl (ICDD 04-004-3791), with some aluminum peaks remaining since this aluminum foil was not lithiated fully (5.8 mAh cm⁻² charge transferred). After a first discharge (i.e., delithiation of the aluminum foil), some of the aluminum peaks increased in intensity, but relatively weak β-LiAl peaks remained. This corresponds to trapped lithium and is consistent with the relatively low initial Coulombic efficiency for high-purity aluminum anodes, as depicted in FIG. 12 and FIG. 14.

After 50 cycles in a delithiated (discharged) state, the XRD results show a mix of β-LiAl and aluminum with increased β-LiAl peak intensity, indicating increased retention of lithium in the anode with cycling. XRD results for aluminum alloy-based anodes are shown in FIG. 29. A pristine foil of the aluminum alloy-based anodes shows a mix of aluminum and indium (ICDD 01-808-5363) phases. After charge (lithiation), both β-LiAl and LiIn (ICDD 04-017-5865) diffraction peaks are evident, as well as aluminum peaks as above. Indium peaks are not present. After delithiation (discharge), only aluminum and LiIn peaks are present, without visible β-LiAl peaks. This is consistent with the relatively high Coulombic efficiency of the aluminum alloy-based anodes in FIG. 12 and FIG. 14, indicating that most of the β-LiAl is delithiated but the LiIn is not. This result contrasts with the aluminum foil in FIG. 28, in which greater amounts of β-LiAl remained even after discharge. After 100 cycles in a discharged state, there remain peaks from Al, β-LiAl, and LiIn; indium peaks are not recovered. Together, these results show that an addition of small amounts of indium enables improved phase reversibility of the β-LiAl phase during cycling, which directly relates to the improved electrochemical stability.

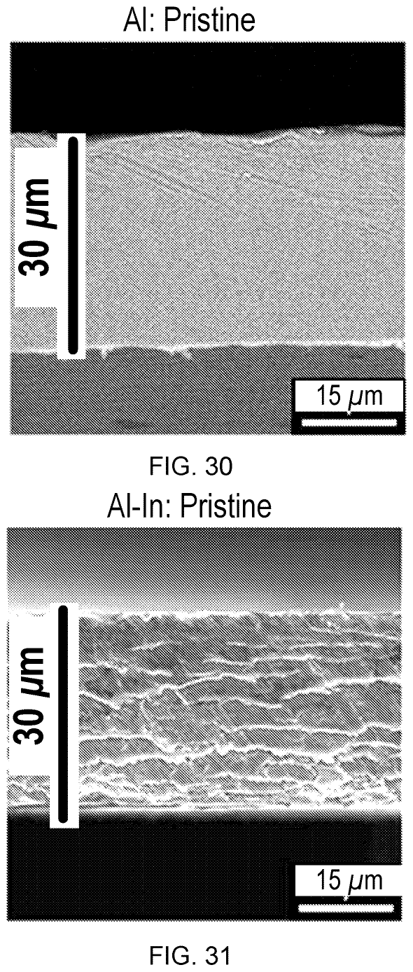

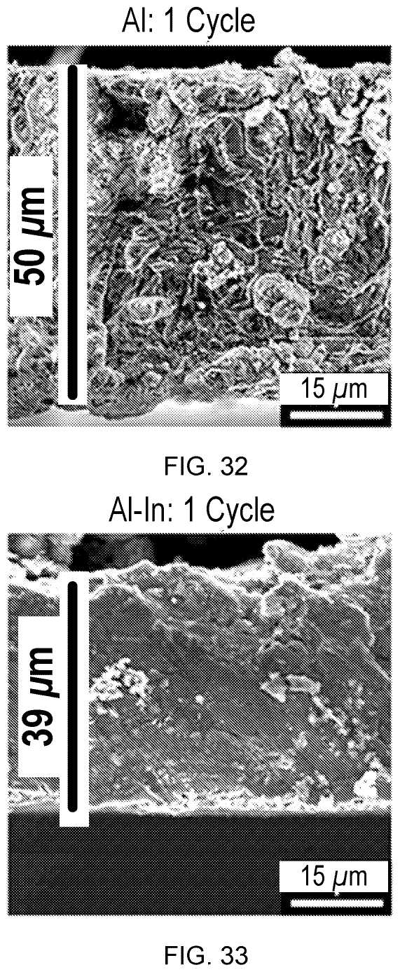

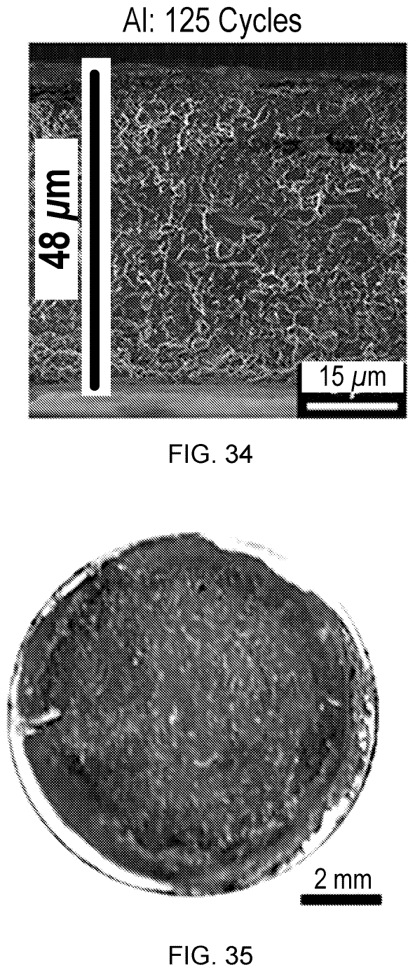

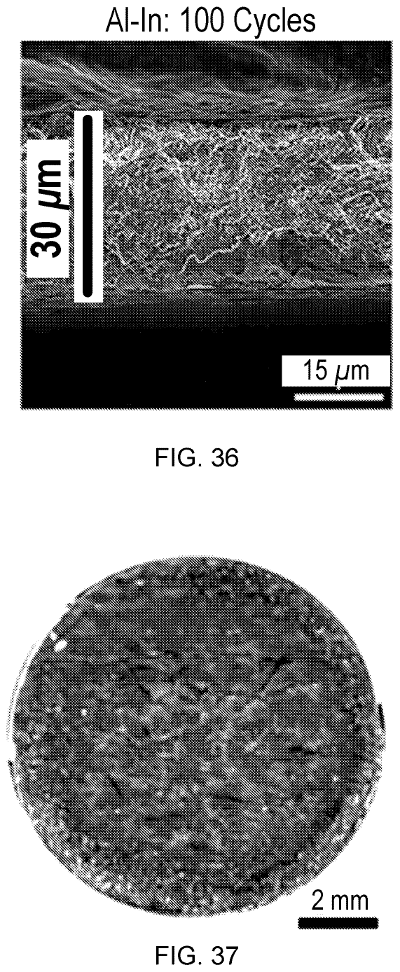

Ex situ SEM was used to track morphological evolution of the two types of anodes in the solid-state cells. A pristine high-purity aluminum anode depicted in FIG. 30 and a pristine aluminum alloy-based anode depicted in FIG. 31 both have an initial thickness of 30 μm. After a first charge/discharge cycle with 5.8 mAh cm⁻² cathode loading, both the high-purity aluminum anode (shown in FIG. 32) and the aluminum alloy-based anode (shown in FIG. 33) showed increases in thickness to 40-50 μm, as expected given a 96% volume expansion to form the β-LiAl phase and some retention of lithium in both cases. A morphology of the high-purity aluminum anode after one cycle (shown in FIG. 32) shows greater nonuniformity and damage than the aluminum alloy-based anode (shown in FIG. 33). After undergoing 125 charge/discharge cycles, the high-purity aluminum anode was mechanically intact and retained its dense character with similar thickness (shown in FIG. 34 and FIG. 35), although the alloying/dealloying process caused a granular structure to develop. The aluminum alloy-based anode showed similar dense granular morphology and approximately 30 μm thickness with an intact electrode after 100 cycles (shown in FIG. 36 and FIG. 37).

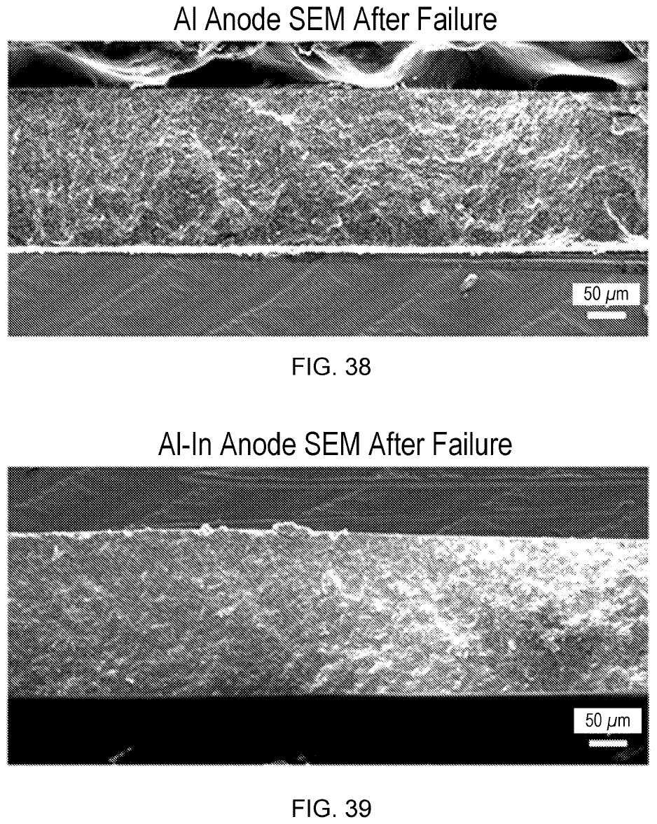

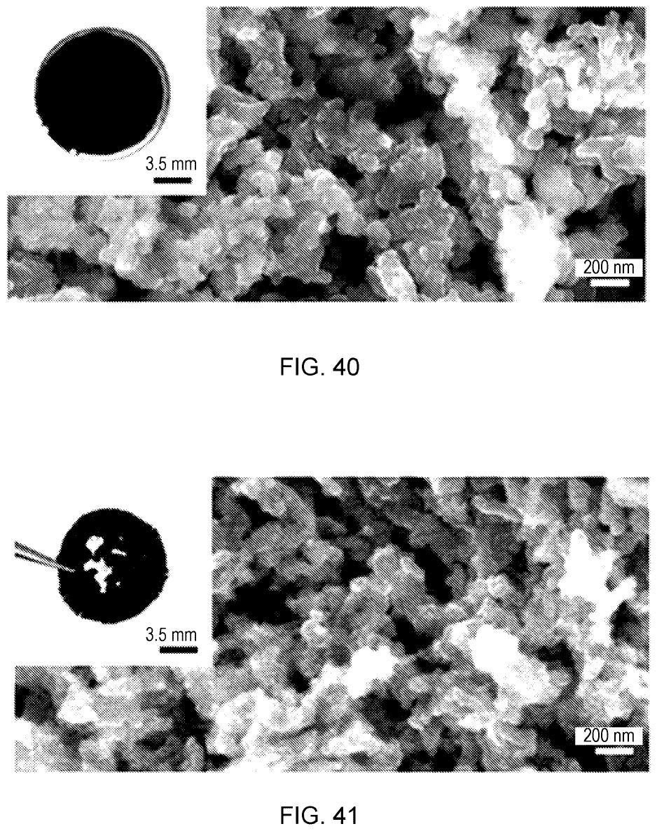

Notably, these results strongly diverge from testing of identical electrodes in liquid-electrolyte cells, where both types of anodes grew from 30 μm to greater than 200 μm thickness at failure in less than 100 cycles. FIG. 38 and FIG. 39 depict cross-sectional SEM images of the high-purity aluminum anode and the aluminum alloy-based anode, respectively, after failure when cycling at 1 mA cm⁻². The high-purity aluminum anode failed when cycling to 59 cycles, and the aluminum alloy-based anode failed when cycling to 54 cycles. This thickening occurs because the anodes become highly porous, as depicted in FIG. 40 and FIG. 41, due to the alloying/dealloying process, and the liquid electrolyte infiltrates the anode to cause continuous interior SEI growth. The anodes in solid-state cells exhibit much less extensive SEI growth due to a planar interface with the solid-state electrolyte. A higher stack pressure and all-solid nature of the solid-state cell stack likely also assist in maintaining dense foils despite structural transformations. These differences are critical for enabling the observed high performance of the aluminum alloy-based anodes in solid-state cells.

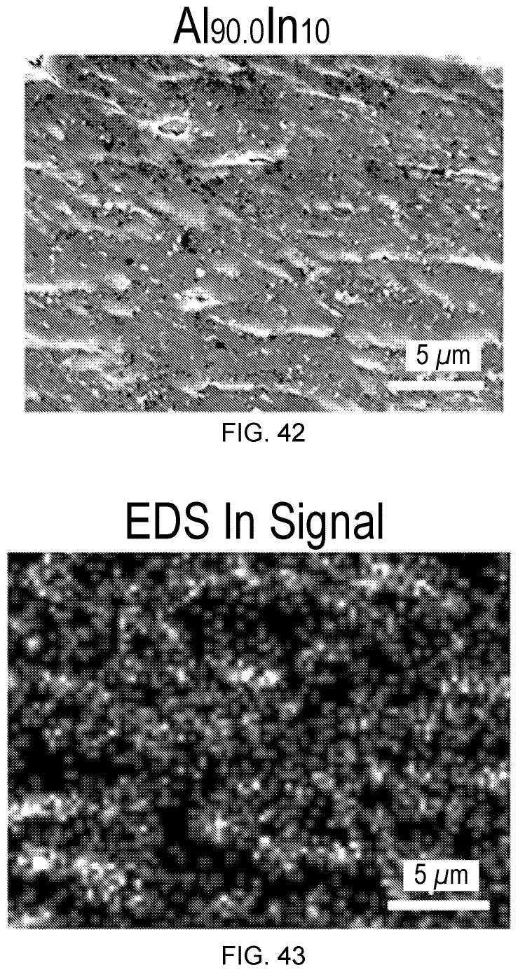

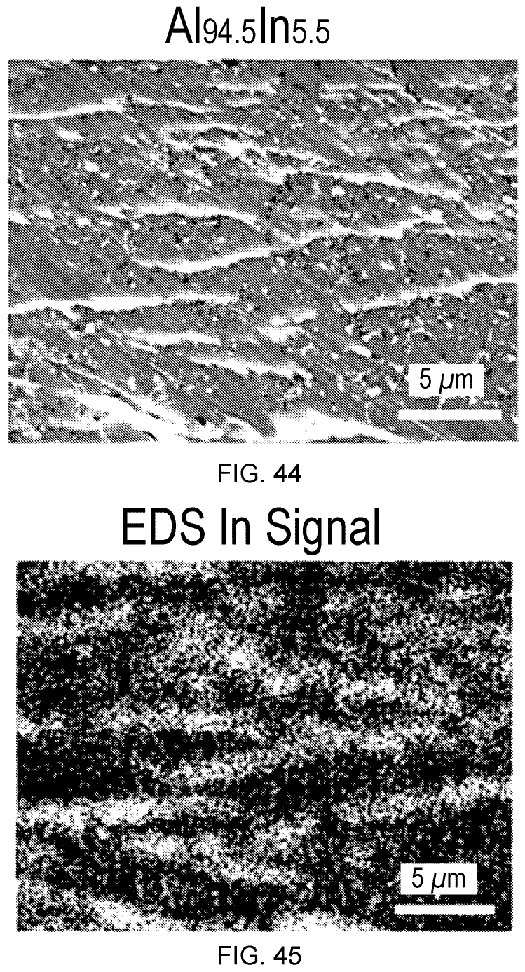

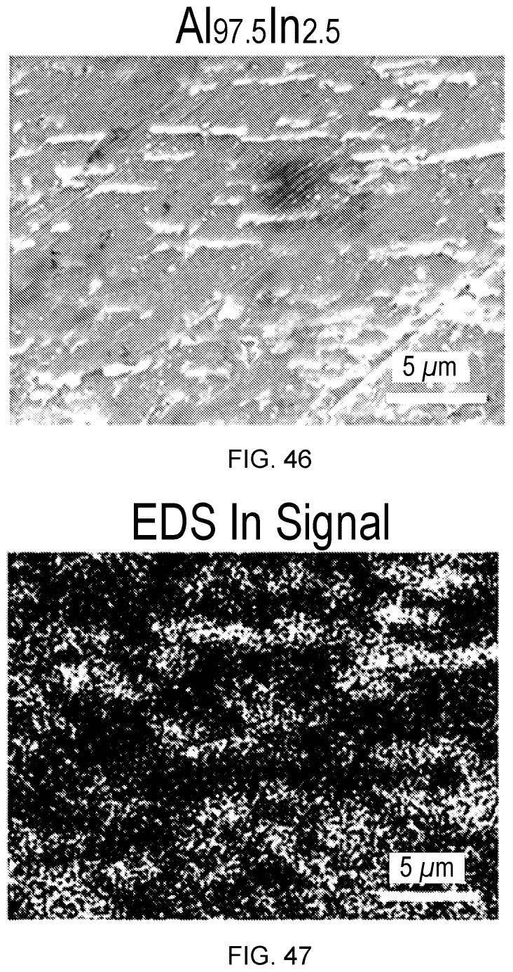

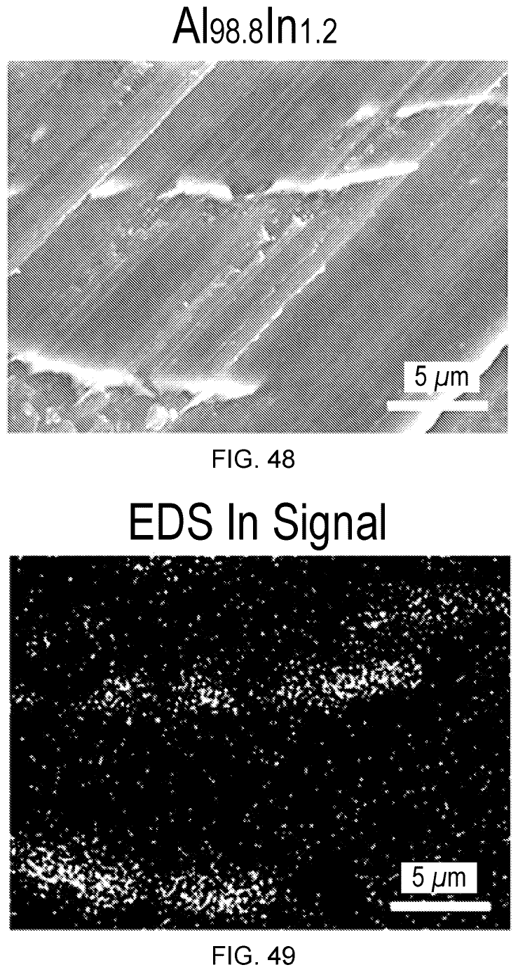

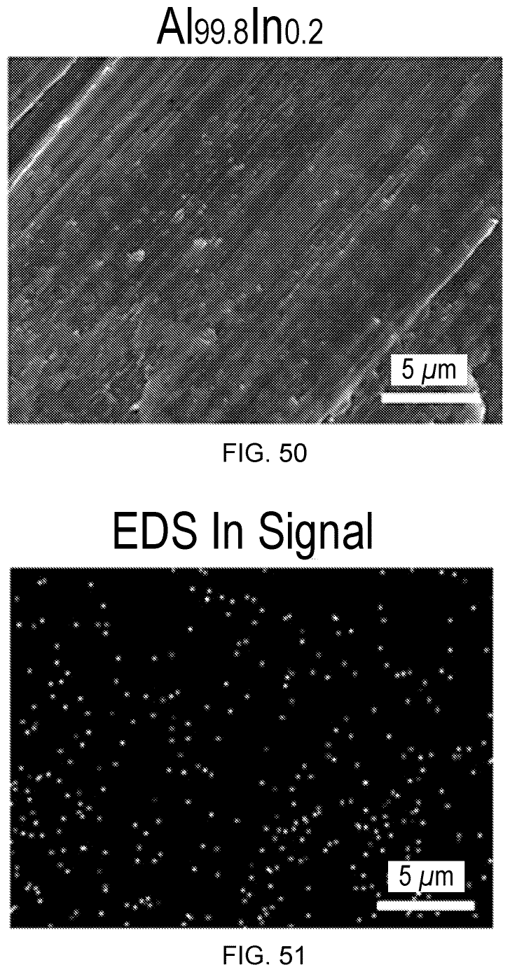

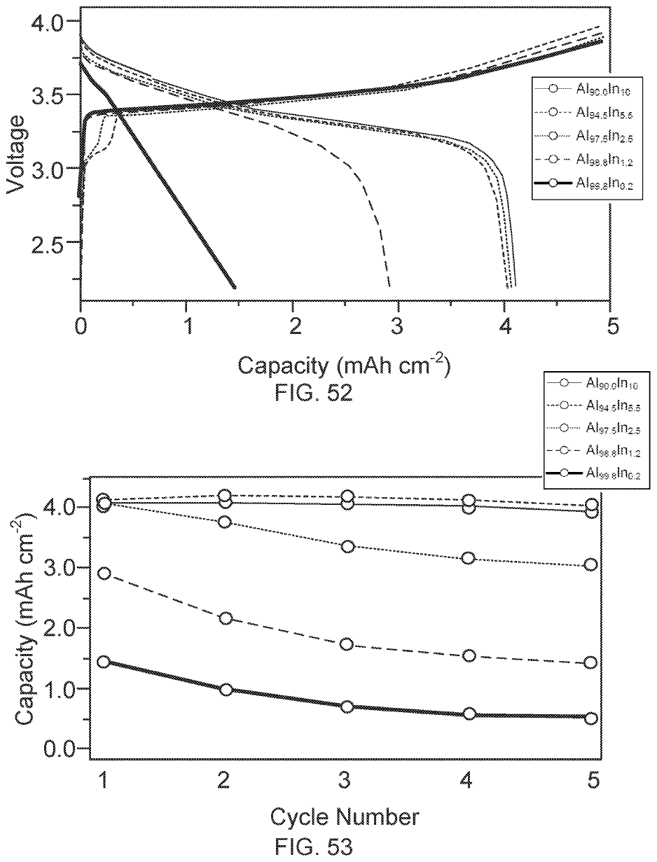

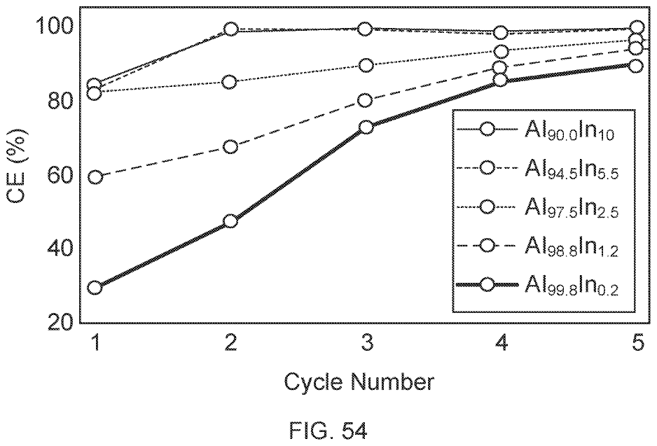

Additional experiments were performed to investigate effects of varying indium content on electrochemical performance. Samples of aluminum alloy-based anodes were prepared with 0.2, 1.2, 2.5, 5.5, and 10 at % indium. All samples formed phase-separated layered microstructures, as depicted in FIG. 42, FIG. 43, FIG. 44, FIG. 45, FIG. 46, FIG. 47, FIG. 48, FIG. 49, FIG. 50, and FIG. 51. Electrochemical testing, as depicted in FIG. 52, FIG. 53, and FIG. 54, showed that a first subset of the samples with less than 2.5 at % indium showed diminished discharge capacity and Coulombic efficiency, while a second subset of the samples with 5.5 at % indium and 10 at % indium showed the highest reversible capacity and Coulombic efficiency of the samples. This result suggests that a minimum threshold of indium is needed to enable sufficiently networked transport pathways to enhance performance.

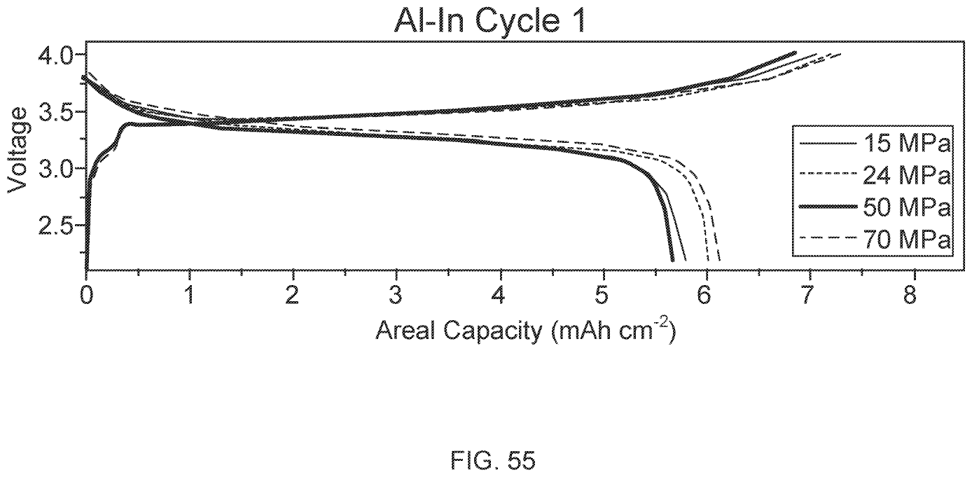

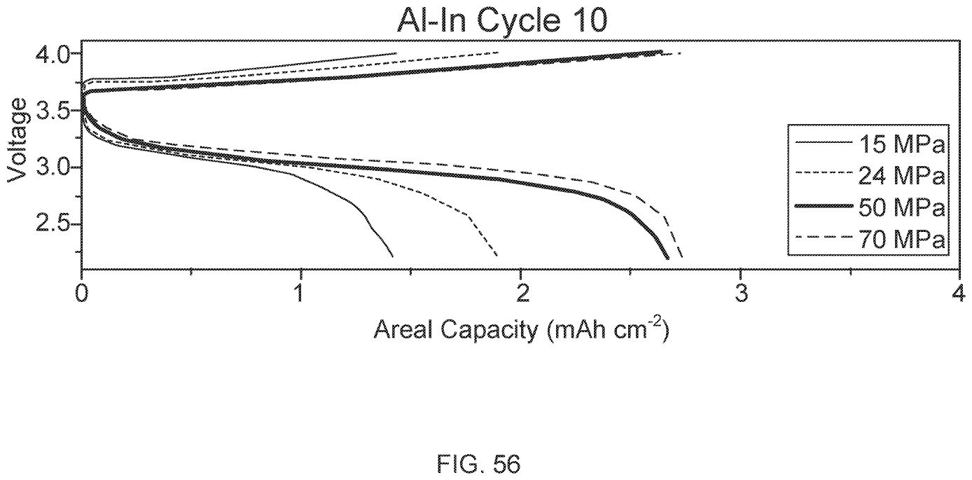

Further experiments were performed to examine effects of applied stack pressure on electrochemical behavior. For solid-state cells with aluminum alloy-based anodes, stack pressures between 15 and 70 MPa showed similar first-cycle voltage curves and Coulombic efficiency, but with slightly improved cycling stability at 50 MPa. Specifically, the stack pressures used include 15 MPa, 24 MPa, 50 MPa, and 70 MPa. FIG. 55 shows voltage vs. areal capacity curves for a first cycle using each stack pressure, and FIG. 56 shows voltage vs. areal capacity curves for a tenth cycle using each stack pressure. Insignificant benefit was found beyond 50 MPa. This range of stack pressures is consistent with reports on alloy anodes for solid-state cells, and it is lower than other demonstrations with lithium metal anodes. Stack pressure affects all components of the solid-state cells (e.g., cathode, separator, anode, and interfaces). With optimized cell design and cathode construction, it is likely that high-capacity cycling at relatively lower stack pressures can be achieved.

Foil-based alloy anodes have been pursued for liquid-electrolyte batteries but have not achieved stable cycling under commercially relevant areal capacity and thickness conditions. The above-described experimental results show the distinct benefits of solid-state architectures, as well as microstructure engineering of foils, for enabling stable cycling of dense aluminum-based foils as anodes for rechargeable battery systems. Based on the experiment results, the aluminum alloy-based anodes remain compact during lithiation and delithiation within solid-state cells and avoid extensive SEI formation that plagues alloys in liquid electrolytes and limits performance. This behavior is likely due to mechanical confinement induced by an all-solid stack, as well as relatively stable and planar interfacial contact with the anode and the solid-state electrolyte, as opposed to a steadily increasing interfacial area in liquid-electrolyte cells. Foil cycling performance can be improved through an addition of minor alloying elements; 5.5 at % indium is shown to enhance reversibility and improve rate behavior. This is due to a distributed high-diffusivity LiIn phase creating transport pathways to enhance rate behavior and minimize lithium trapping. These experimental results can highlight a new class of anode materials for Li-based electrochemical cells that may eliminate slurry coating, which makes up a relatively large portion of costs and energy requirements in battery manufacturing. Furthermore, foil anodes offer a possibility of using a single structure as both an ion-storage electrode and a current collector.

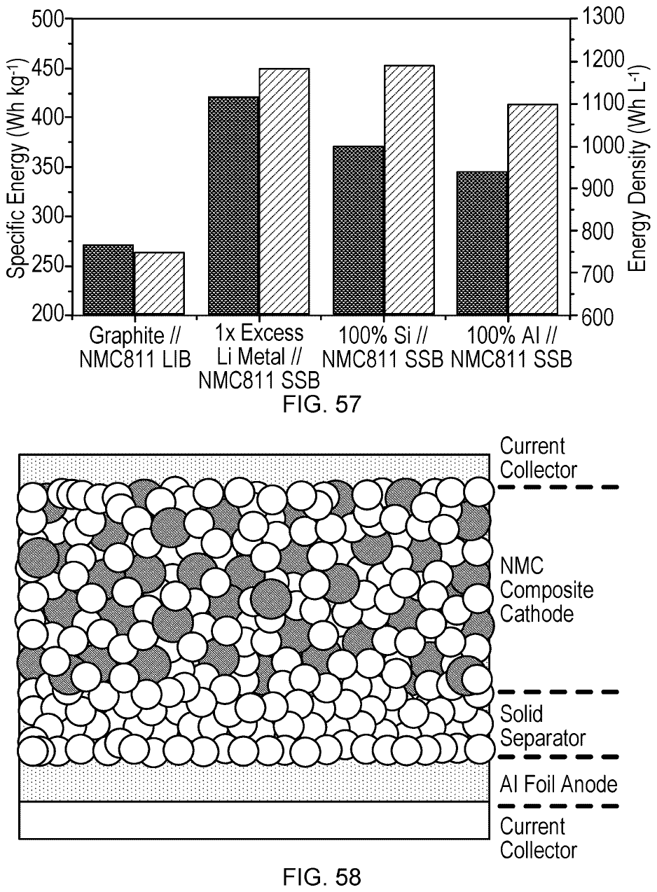

Calculations at a stack level (i.e., without considering external packaging) were performed to determine specific energy (Wh kg⁻¹) and energy density (Wh L⁻¹) for various battery configurations, as depicted in FIG. 57 and FIG. 58. Specifically, the calculations considered the separator, anode, cathode, and current collectors of the various battery configurations. All cells of the various battery configurations assumed an areal discharge capacity of 4 mAh cm⁻², a 20-μm separator, a 10-μm copper (8.96 g cm⁻³) current collector, and a 10-μm aluminum (2.7 g cm⁻³) current collector. For a Li-ion liquid electrolyte cell, an active cathode material is NMC 811 with a theoretical discharge capacity of 200 mAh g⁻¹ and density of 4.78 g cm⁻³. A slurry cast cathode has 96 wt. % active material, 2% binder, and 2% conductive additive. The slurry cast cathode has 30% porosity and a total thickness of 66 μm. The N:P ratio is 1.1, so a graphite anode would hold 4.4 mAh cm⁻². Similar conditions of 96 wt. % active material, 2 wt. % binder, and 2 wt. % conductive additive were applied to the slurry cast anode. The electrode has 32% porosity and a total thickness of 85 μm. The polypropylene separator has a density of 0.92 g cm⁻³, and the electrolyte has a density of 1.3 g cm⁻³. The mean discharge voltage of this cell is 3.7 V.

For calculations corresponding to a solid-state electrochemical cell, the solid-state electrolyte is Li₆PS₅Cl with a density of 1.86 g cm⁻³. The SSE is 20-μm thick. The active cathode material is NMC 811. The composite is 80 wt. % NMC 811, 17.5 wt. % SSE, and 2.5 wt. % conductive carbon. The composite electrode has a total thickness of 69 μm. For an excess lithium anode, the N:P ratio is 1.0 so that the lithium metal foil would hold 4.0 mAh cm⁻². Lithium's specific capacity is 3860 mAh g⁻¹ and has a density of 0.534 g cm⁻³. The thickness of the excess lithium anode is 19 μm. The mean discharge voltage of this cell is 3.8 V. For a dense silicon anode, the N:P ratio is 1.1 so the slurry-cast 99.9% silicon anode would hold 4.4 mAh cm⁻². Silicon's specific capacity is 3579 mAh g⁻¹ and has a density of 2.3 g cm⁻³. The binder is PTFE and makes up 0.1 wt. % of the slurry cast anode. The anode thickness is 9 μm. The mean discharge voltage of this cell is 3.4 V. For an aluminum foil anode, the N:P ratio is 1.1 so the aluminum foil anode would hold 4.4 mAh cm⁻².

Aluminum's specific capacity is 990 mAh g⁻¹ and has a density of 2.7 g cm⁻³. The anode thickness is 16 μm. The mean discharge voltage of this cell is 3.45 V.

### Illustrative Aspects

As used below, any reference to a series of aspects (e.g., “Aspects 1-4”) or non-enumerated group of aspects (e.g., “any previous or subsequent aspect”) is to be understood as a reference to each of those aspects disjunctively (e.g., “Aspects 1-4” is to be understood as “Aspects 1, 2, 3, or 4”).

Aspect 1 is a solid-state battery, comprising: an anode, the anode comprising a composite foil including: a first metal phase comprising aluminum or an aluminum alloy, wherein the first metal phase comprises or represents from 50 at % to 99 at % of the composite foil; and a second metal phase interspersed with the first metal phase, the second metal phase comprising a conductive element having a lithium alloying potential that is higher than or about equal to that of aluminum and wherein a lithiated form of the conductive element exhibits a lithium-ion conductivity or diffusion coefficient greater than or about equal to that of lithiated aluminum, and wherein the second metal phase comprises or represents from 1 at % to 50 at % of the composite foil; a cathode; and a solid-state electrolyte between the anode and the cathode.

Aspect 2 is the solid-state battery of any previous or subsequent aspect, wherein the first metal phase comprises a 1xxx series aluminum alloy, a 2xxx series aluminum alloy, a 3xxx series aluminum alloy, a 4xxx series aluminum alloy, a 5xxx series aluminum alloy, a 6xxx series aluminum alloy, a 7xxx series aluminum alloy, an 8xxx series aluminum alloy, or a recycled content aluminum alloy.

Aspect 3 is the solid-state battery of any previous or subsequent aspect, wherein the conductive element is silicon, tin, indium, carbon, gallium, antimony, lead, nickel, copper, germanium, zinc, bismuth, magnesium, manganese, or silver.

Aspect 4 is the solid-state battery of any previous or subsequent aspect, wherein the second phase is present as a plurality of individual domains within the first metal phase.

Aspect 5 is the solid-state battery of any previous or subsequent aspect, wherein at least some of the individual domains exhibit a cross-sectional dimension of less than 5 μm or less than 1 μm.

Aspect 6 is the solid-state battery of any previous or subsequent aspect, wherein the second metal phase comprises the lithiated form of the conductive element.

Aspect 7 is the solid-state battery of any previous or subsequent aspect, wherein the conductive element comprises In and the second metal phase comprises Li—In.

Aspect 8 is the solid-state battery of any previous or subsequent aspect, wherein the composite foil exhibits a lithium diffusion coefficient of from about 10⁻⁵ cm² s⁻¹ to 10⁻¹⁰ cm² s⁻¹.

Aspect 9 is the solid-state battery of any previous or subsequent aspect, wherein the solid-state electrolyte is an inorganic solid electrolyte.

Aspect 10 is the solid-state battery of any previous or subsequent aspect, wherein the solid-state electrolyte comprises a lithium argyrodite material, Li₆PS₅Cl, a lithium super ionic conductor (LISICON), a doped garnet material, Li₇La₃Zr₂O₁₂ (LLZO), Li₁₀GeP₂S₁₂, Li₁₀SnP₂S₁₂, lithium phosphorus sulfide (Li₃PS₄), halide materials, Li₃YCl₆, lithium phosphorus oxynitride (LIPON), a polymer solid electrolyte, or a gel-polymer electrolyte.

Aspect 11 is the solid-state battery of any previous or subsequent aspect, wherein the solid-state electrolyte has a thickness of from 10 μm to 300 μm.

Aspect 12 is the solid-state battery of any previous or subsequent aspect, wherein the composite foil exhibits a change in thickness after 100 charge-discharge cycles of less than 50%.

Aspect 13 is the solid-state battery of any previous or subsequent aspect, wherein the cathode comprises a lithium host material, a lithium transition metal oxide cathode, lithium nickel manganese cobalt oxide, lithium nickel cobalt aluminum oxide, lithium manganese oxide, lithium iron phosphate, lithium cobalt oxide, a conversion cathode, lithiated FeS₂, lithiated FeF₃, a sulfur-based cathode, or sulfur.

Aspect 14 is the solid-state battery of any previous or subsequent aspect, further comprising one or more of: a cathode current collector in contact with the cathode; or an anode current collector in contact with the anode.

Aspect 15 is the solid-state battery of any previous or subsequent aspect, wherein the anode current collector comprises a protected aluminum alloy foil.

Aspect 16 is the solid-state battery of any previous or subsequent aspect, wherein the solid-state battery does not include or comprise an anode current collector or wherein the composite foil functions as an anode current collector without a separate anode current collector.

Aspect 17 is the solid-state battery of any previous or subsequent aspect, wherein a stack pressure is applied between the anode and the cathode, and wherein the stack pressure is from 0.1 MPa to 70 MPa.

Aspect 18 is the solid-state battery of any previous or subsequent aspect, wherein the composite metal foil has a thickness of from 2 μm to 60 μm.

Aspect 19 is the solid-state battery of any previous or subsequent aspect, wherein the composite foil exhibits a specific capacity of from 300 mAh/g to 1000 mAh/g.

Aspect 20 is the solid-state battery of any previous or subsequent aspect, further comprising an interface material between the anode and the solid-state electrolyte.

Aspect 21 is the solid-state battery of any previous or subsequent aspect, wherein the interface material comprises a solid-electrolyte interphase, an artificial solid-electrolyte interphase, a polymer coating, a carbon coating, or an inorganic coating.

Aspect 22 is a method of making a solid-state battery, the method comprising: providing an anode, the anode comprising a composite foil including: a first metal phase comprising aluminum or an aluminum alloy, wherein the first metal phase comprises or represents from 50 at % to 99 at % of the composite foil; and a second metal phase interspersed with the first metal phase, the second metal phase comprising a conductive element having a lithium alloying potential that is higher than or about equal to that of aluminum and wherein a lithiated form of the conductive element exhibits a lithium-ion conductivity or diffusion coefficient greater than or about equal to that of lithiated aluminum, and wherein the second metal phase comprises or represents from 1 at % to 50 at % of the composite foil; providing a cathode; and positioning a solid-state electrolyte between the anode and the cathode.

Aspect 23 is the method of any previous or subsequent aspect, wherein providing the anode comprises: casting a molten metal mixture comprising aluminum or the aluminum alloy and the conductive element to create an aluminum-based multi-component product; and rolling the aluminum-based multi-component product into the composite foil.

Aspect 24 is the method of any previous or subsequent aspect, further comprising one or more of: contacting the anode with an anode current collector; or contacting the cathode with a cathode current collector.

Aspect 25 is the method of any previous aspect, wherein the solid-state battery comprises the solid-state battery of any previous aspect.

All patents and publications cited herein are incorporated by reference in their entirety. The foregoing description of the embodiments, including illustrated embodiments, has been presented only for the purpose of illustration and description and is not intended to be exhaustive or limiting to the precise forms disclosed. Numerous modifications, adaptations, and uses thereof will be apparent to those skilled in the art.

1. A solid-state battery, comprising:
an anode, the anode comprising a composite foil including:
a first metal phase comprising aluminum or an aluminum alloy, wherein the first metal phase comprises or represents from 50 at % to 99 at % of the composite foil; and
a second metal phase interspersed with the first metal phase, the second metal phase comprising a conductive element having a lithium alloying potential that is higher than or about equal to that of aluminum and wherein a lithiated form of the conductive element exhibits a lithium-ion conductivity or diffusion coefficient greater than or about equal to that of lithiated aluminum, and wherein the second metal phase comprises or represents from 1 at % to 50 at % of the composite foil;
a cathode; and
a solid-state electrolyte between the anode and the cathode.

2. The solid-state battery of claim 1, wherein the first metal phase comprises a 1xxx series aluminum alloy, a 2xxx series aluminum alloy, a 3xxx series aluminum alloy, a 4xxx series aluminum alloy, a 5xxx series aluminum alloy, a 6xxx series aluminum alloy, a 7xxx series aluminum alloy, an 8xxx series aluminum alloy, or a recycled content aluminum alloy.

3. The solid-state battery of claim 1, wherein the conductive element is silicon, tin, indium, carbon, gallium, antimony, lead, nickel, copper, germanium, zinc, bismuth, magnesium, manganese, or silver.

4. The solid-state battery of claim 1, wherein the second metal phase is present as a plurality of individual domains within the first metal phase.

5. The solid-state battery of claim 4, wherein at least some of the plurality of individual domains exhibit a cross-sectional dimension of less than 5 μm or less than 1 μm.

6. The solid-state battery of claim 1, wherein the second metal phase comprises the lithiated form of the conductive element.

7. The solid-state battery of claim 6, wherein the conductive element comprises In and the second metal phase comprises Li—In.

8. The solid-state battery of claim 1, wherein the composite foil exhibits a lithium diffusion coefficient of from about 10⁻⁵ cm² s⁻¹ to 10¹⁰ cm² s⁻¹.

9. The solid-state battery of claim 1, wherein the solid-state electrolyte is an inorganic solid electrolyte.

10. The solid-state battery of claim Error! Reference source not found., wherein the solid-state electrolyte comprises a lithium argyrodite material, Li₆PS₅Cl, a lithium super ionic conductor (LISICON), a doped garnet material, Li₇La₃Zr₂O₁₂ (LLZO), Li₁₀GeP₂S₁₂, Li₁₀SnP₂S₁₂, lithium phosphorus sulfide (Li₃PS₄), halide materials, Li₃YCl₆, lithium phosphorus oxynitride (LIPON), a polymer solid electrolyte, or a gel-polymer electrolyte.

11. The solid-state battery of claim 1, wherein the solid-state electrolyte has a thickness of from 10 μm to 300 μm.

12. The solid-state battery of claim 1, wherein the composite foil exhibits a change in thickness after 100 charge-discharge cycles of less than 50%.

13. The solid-state battery of claim Error! Reference source not found., wherein the cathode comprises a lithium host material, a lithium transition metal oxide cathode, lithium nickel manganese cobalt oxide, lithium nickel cobalt aluminum oxide, lithium manganese oxide, lithium iron phosphate, lithium cobalt oxide, a conversion cathode, lithiated FeS₂, lithiated FeF₃, a sulfur-based cathode, or sulfur.

14. The solid-state battery of claim 1, further comprising one or more of:
a cathode current collector in contact with the cathode; or an anode current collector in contact with the anode.

15. (canceled)

16. The solid-state battery of claim 1, wherein the solid-state battery does not include or comprise an anode current collector or wherein the composite foil functions as an anode current collector without a separate anode current collector.

17. The solid-state battery of claim 1, wherein a stack pressure is applied between the anode and the cathode, and wherein the stack pressure is from 0.1 MPa to 70 MPa.

18. The solid-state battery of claim 1, wherein the composite foil has a thickness of from 2 μm to 60 μm.

19. (canceled)

20. The solid-state battery of claim 1, further comprising an interface material between the anode and the solid-state electrolyte.

21. The solid-state battery of claim 20, wherein the interface material comprises a solid-electrolyte interphase, an artificial solid-electrolyte interphase, a polymer coating, a carbon coating, or an inorganic coating.

22. A method of making a solid-state battery, the method comprising:
providing an anode, the anode comprising a composite foil including:
a first metal phase comprising aluminum or an aluminum alloy, wherein the first metal phase comprises or represents from 50 at % to 99 at % of the composite foil; and
a second metal phase interspersed with the first metal phase, the second metal phase comprising a conductive element having a lithium alloying potential that is higher than or about equal to that of aluminum and wherein a lithiated form of the conductive element exhibits a lithium-ion conductivity or diffusion coefficient greater than or about equal to that of lithiated aluminum, and wherein the second metal phase comprises or represents from 1 at % to 50 at % of the composite foil;
providing a cathode; and
positioning a solid-state electrolyte between the anode and the cathode.

23-25. (canceled)
